(19) United States
(12) Patent Application Publication
(10) Pub. No.: US 2018/0232178 A1
(43) Pub. Date: Aug. 16, 2018

(54) MEMORY CONTROLLER, MEMORY SYSTEM, AND METHOD OF CONTROLLING MEMORY CONTROLLER

(71) Applicant: Sony Corporation, Tokyo (JP)

(72) Inventors: Hiroyuki Iwaki, Kanagawa (JP); Ken Ishii, Tokyo (JP); Yasushi Fujinami, Tokyo (JP); Kennichi Nakanishi, Tokyo (JP); Tatsuo Shinbashi, Tokyo (JP)

(21) Appl. No.: 15/750,280

(22) PCT Filed: Jun. 15, 2016
(86) PCT No.: PCT/JP2016/067731

§ 371 Date: Feb. 5, 2018

(30) Foreign Application Priority Data
Sep. 8, 2015 (JP) 2015-176786
May 13, 2016 (JP) 2016-096618

(51) Int. Cl. G06F 3/06; G06F 12/10

(52) U.S. Cl. CPC G06F 3/0659; G06F 3/0611; G06F 2212/1024; G06F 12/10; G06F 3/0673

(57) ABSTRACT

An access speed when a memory controller accesses a memory is improved.

Each time any one of two different types of commands is input, a holding unit holds the input command. A priority mode switching unit switches a priority command which should have priority out of the two commands from one of the two commands to the other. A command processing unit preferentially extracts priority commands sequentially from the holding unit, and then sequentially extracts commands which are not the priority commands from the holding unit.

### TECHNICAL FIELD

The present technology relates to a memory controller, a memory system, and a method of controlling a memory controller. Specifically, this relates to a memory controller which holds a command in a queue, a memory system, and a method of controlling a memory controller.

### BACKGROUND ART

In recent information processing systems, a non-volatile memory (NVM) may be used as an auxiliary storage device or a storage. This non-volatile memory is roughly divided into a flash memory compatible with data access in a large size unit and a non-volatile random access memory (non-volatile RAM: NVRAM) capable of high-speed random access in a small unit. Herein, as a representative example of the flash memory, there is a NAND flash memory. In contrast, examples of the non-volatile random access memory include a resistive RAM (ReRAM), a phase-change RAM (PCRAM), a magnetoresistive RAM (MRAM) and the like.

A memory controller has been proposed in which a write command and a read command are held in a queue, and these commands are extracted in order of arrival and processed when accessing these non-volatile memories (refer to, for example, Patent Document 1). The commands are buffered in the queue in this manner in order to alleviate difference in processing speed and transfer speed between a host computer which issues these commands and the memory controller.

### CITATION LIST

### Patent Document

Patent Document 1: Japanese Patent Application Laid-Open No. 2007-47274

### SUMMARY OF THE INVENTION

### Problems to be Solved by the Invention

However, in the above-described conventional technology, when the write command and the read command are issued in a mixed manner, there is a risk that inefficient access is performed and the access speed is lowered. For example, when processing the write command after the read command, the memory controller is required to process the write command after reading of read data is completed in order to avoid collision of the read data with the write data on a data line. For this reason, there is a problem that, as the number of times the read command and the write command are alternately issued increases, accumulated standby time for the processing of the write command until the reading of the read data is completed becomes longer and the access speed decreases.

The present technology is achieved in view of such a situation, and an object thereof is to improve the access speed when the memory controller accesses the memory.

### Solutions to Problems

The present technology is made to solve the above-described problems, and a first aspect thereof is a memory controller provided with a holding unit which, each time any one of two different types of commands is input, holds the input command, a switching unit which switches a priority command which should have priority out of the two commands from one of the two commands to the other, and a command processing unit which preferentially extracts priority commands sequentially from the holding unit, and then sequentially extracts commands which are not the priority command from the holding unit, and a method of controlling the same. As a result, there is an effect that the priority command is switched from one of the two commands to the other.

The command processing unit may sequentially extract all the priority commands from the holding unit, and then sequentially extract the commands which are not the priority commands from the holding unit. As a result, there is an effect that, after all of the priority commands are extracted, the commands which are not the priority commands are extracted.

Also, in the first aspect, a counting unit which counts the number of each of the two commands to generate a count value is further provided, in which the switching unit may switch the priority command on the basis of whether the count value of each of the two commands exceeds a predetermined threshold. As a result, there is an effect that the priority command is switched on the basis of whether the count value of each of the commands exceeds the threshold.

Also, in the first aspect, the counting unit may count the number of the commands held in the holding unit. As a result, there is an effect that the priority command is switched on the basis of the number of commands held in the holding unit.

Also, in the first aspect, the counting unit may count the number of the commands extracted from the holding unit. As a result, there is an effect that the priority command is switched on the basis of the number of commands extracted from the holding unit.

Also, in the first aspect, an address converting unit which performs logical to physical address conversion to convert a logical address specified by the command to a physical address is further provided, in which the holding unit may include a memory command holding unit which holds the command subjected to the logical to physical address conversion as a memory command, and a host command holding unit which holds the command before the address conversion is performed as a host command. As a result, there is an effect that the priority command is switched on the basis of the number of host commands or memory commands.

Also, in the first aspect, the counting unit may count the number of host commands held in the host command holding unit. As a result, there is an effect that the priority mode is switched on the basis of the number of held host commands.

Also, in the first aspect, the counting unit may count the number of memory commands held in the memory command holding unit as the number of standby commands, and count the number of memory commands extracted from the memory command holding unit as the number of processed commands, the threshold may be the number of standby commands when the priority command is switched, and the switching unit may switch the priority command on the basis of whether the number of processed commands exceeds the threshold. As a result, there is an effect that the priority command is switched on the basis of whether the number of processed commands exceeds the number of standby commands when switching the priority command.

Also, in the first aspect, the priority mode switching unit may switch the priority command each time a certain period of time elapses. As a result, there is an effect that the priority command is switched each time a certain period of time elapses.

Also, in the first aspect, the switching unit may switch the priority command according to a specific command giving an instruction to switch the priority command. As a result, there is an effect that the priority command is switched by a specific command.

Also, in the first aspect, one of the two commands may be a read command giving an instruction to read data, the other of the two commands may be a write command giving an instruction to write data, and the holding unit may include a read command holding unit which holds the read command, and a write command holding unit which holds the write command. As a result, there is an effect that the command is held in the read command holding unit and the write command holding unit.

Also, a second aspect of the present technology is a memory system provided with a memory cell, a holding unit which, each time any one of two different commands for accessing the memory cell is input, holds the input command, a switching unit which switches a priority command which should have priority out of the two commands from one of the two commands to the other, and a command processing unit which preferentially extracts priority commands sequentially from the holding unit, and then sequentially extracts commands which are not the priority command from the holding unit. As a result, there is an effect that the priority command is switched from one of the two commands to the other.

### Effects of the Invention

According to the present technology, it is possible to obtain an excellent effect that the access speed when the memory controller accesses the memory may be improved. Meanwhile, the effects are not necessarily limited to the effects herein described and may be any of the effects described in the present disclosure.

### BRIEF DESCRIPTION OF DRAWINGS

FIG. 1 is block diagram illustrating a configuration example of a memory system in a first embodiment.

FIG. 2 is a block diagram illustrating a configuration example of a memory controller in the first embodiment.

FIG. 3 is a block diagram illustrating a functional configuration example of the memory controller in the first embodiment.

FIG. 4 is a block diagram illustrating a configuration example of a request issue control unit in the first embodiment.

FIG. 5 is a view illustrating a configuration example of a command queue in the first embodiment.

FIG. 6 is a view illustrating an example of operation of a priority mode switching unit in the first embodiment.

FIG. 7 is a block diagram illustrating a configuration example of a request issue managing unit in the first embodiment.

FIG. 8 is a view illustrating an example of operation of an extracted command switch control unit in the first embodiment.

FIG. 9 is a view illustrating an example of operation of a request issuing unit in the first embodiment.

FIG. 10 is an example of a state transition diagram of the memory controller in the first embodiment.

FIG. 11 is a block diagram illustrating a configuration example of a non-volatile memory in the first embodiment.

FIG. 12 is a view illustrating an example of resistance distribution of variable resistance elements in the first embodiment.

FIG. 13 is a flowchart illustrating an example of operation of the memory controller in the first embodiment.

FIG. 14 is a flowchart illustrating an example of request issue processing in the first embodiment.

FIG. 15 is a timing chart illustrating an example of the operation of the memory controller in a read priority mode in the first embodiment.

FIG. 16 is a timing chart illustrating an example of the operation of the memory controller in a write priority mode in the first embodiment.

FIG. 17 is a block diagram illustrating a configuration example of a request issue control unit in a second embodiment.

FIG. 18 is a view illustrating an example of operation of a priority mode switching unit in the second embodiment.

FIG. 19 is an example of a state transition diagram of a memory controller in the second embodiment.

FIG. 20 is a view illustrating an example of operation of the memory controller in the second embodiment.

FIG. 21 is a graph representing an example of change in queue occupancy in the second embodiment.

FIG. 22 is a graph representing an example of the change in queue occupancy in a case where a threshold is changed in the second embodiment.

FIG. 23 is a graph representing an example of change in queue occupancy of a write command in a comparative example fixed to read priority.

FIG. 24 is a graph representing an example of the change in the queue occupancy of the write command in the comparative example fixed to write priority.

FIG. 25 is a block diagram illustrating a configuration example of a request issue control unit in a third embodiment.

FIG. 26 is a view illustrating an example of operation of a priority mode switching unit in the third embodiment.

FIG. 27 is an example of a state transition diagram of a memory controller in the third embodiment.

FIG. 28 is a view illustrating an example of operation of the memory controller in the third embodiment.

FIG. 29 is a block diagram illustrating a configuration example of a request issue control unit in a fourth embodiment.

FIG. 30 is a view illustrating an example of operation of a priority mode switching unit in the fourth embodiment.

FIG. 31 is an example of a state transition diagram of a memory controller in the fourth embodiment.

FIG. 32 is a view illustrating an example of operation of the memory controller in the fourth embodiment.

FIG. 33 is a block diagram illustrating a configuration example of a request issue control unit in a fifth embodiment.

FIG. 34 is an example of a state transition diagram of a memory controller in the fifth embodiment.

FIG. 35 is a timing chart illustrating an example of operation of the memory controller in a fifth embodiment.

FIG. 36 is a timing chart illustrating an example of operation of a memory controller in a comparative example.

FIG. 37 is a flowchart illustrating an example of operation of the memory controller in the fifth embodiment.

FIG. 38 is a block diagram illustrating a configuration example of a request issue control unit in a sixth embodiment.

FIG. 39 is a view illustrating an example of operation of a priority mode switching unit in the sixth embodiment.

FIG. 40 is an example of a state transition diagram of the memory controller in the sixth embodiment.

FIG. 41 is a timing chart illustrating an example of operation of the memory controller in the sixth embodiment.

FIG. 42 is a flowchart illustrating an example of the operation of the memory controller in the sixth embodiment.

### MODE FOR CARRYING OUT THE INVENTION

A mode for carrying out the present technology (hereinafter, referred to as an embodiment) is hereinafter described. The description is given in the following order.

1. First Embodiment (Example of Switching Priority Mode on the Basis of Number of Standby Commands)

2. Second Embodiment (Example of Switching Priority Mode on the Basis of Number of Processed Commands)

3. Third Embodiment (Example of Switching Priority Mode Each Time Certain Period of Time Elapses)

4. Fourth Embodiment (Example of Switching Priority Mode on the Basis of Number of Processed Commands or Switching Command)

5. Fifth Embodiment (Example of Switching Priority Mode on the Basis of Number of Host Commands)

6. Sixth Embodiment (Example of Switching Priority Mode on the Basis of Threshold Which Is Dynamically Changed)

### 1. First Embodiment

### [Configuration Example of Memory System]

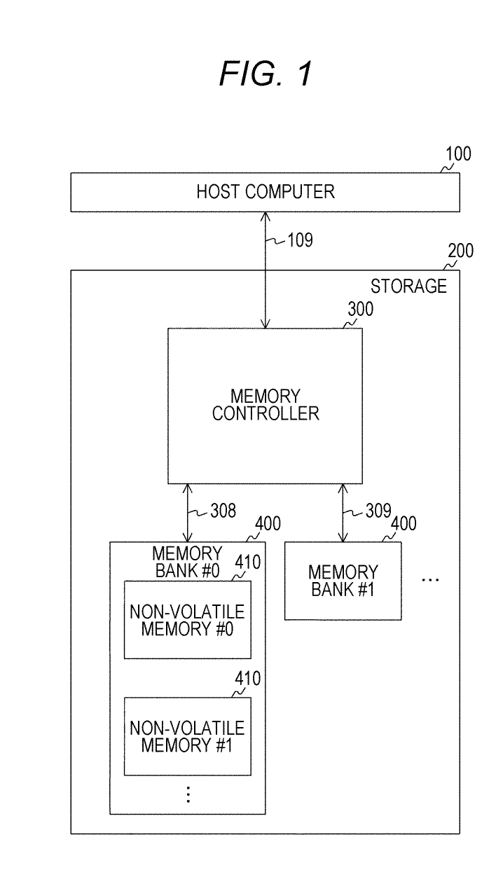

FIG. 1 is a block diagram illustrating a configuration example of a memory system in an embodiment. The memory system is provided with a host computer 100 and a storage 200.

The host computer 100 controls an entire memory system. Specifically, the host computer 100 generates a command and data and supplies them to the storage 200 via a signal line 109. The host computer 100 also receives data which is read from the storage 200. Herein, the command is for controlling the storage 200 and includes, for example, a write command specifying a logical address to give an instruction to write the data, and a read command specifying a logical address to give an instruction to read the data. Herein, the logical address is an address allocated to each access unit when the host computer 100 accesses the storage 200.

The storage 200 is provided with a memory controller 300 and a plurality of memory banks 400. Each of the memory banks 400 is provided with a plurality of non-volatile memories 410. The memory controller 300 controls an entire storage 200. In a case where the memory controller 300 receives the write command and the data from the host computer 100, this generates an error detection and correction code (ECC) from the data. The memory controller 300 accesses each of the memory banks 400 via signal lines 308 and 309 to write encoded data.

Also, in a case where the memory controller 300 receives the read command from the host computer 100, this accesses the memory bank 400 via the signal line 308 and the like to read the encoded data. Then, the memory controller 300 converts (that is, decodes) the encoded data into original data before encoding. At the time of decoding, the memory controller 300 detects to correct an error in the data on the basis of the ECC. The memory controller 300 supplies the corrected data to the host computer 100.

The non-volatile memory 410 stores the data under the control of the memory controller 300. For example, a ReRAM is used as the non-volatile memory 410. The non-volatile memory 410 is provided with a plurality of memory cells, and these memory cells are divided into a plurality of blocks. Herein, the block is an access unit of the non-volatile memory 410 and is also called as a sector. A memory address is allocated to each of the blocks. Meanwhile, a flash memory, a PCRAM, an MRAM and the like may also be used as the non-volatile memory 410 in place of the ReRAM.

Meanwhile, although a plurality of memory banks 400 is provided in the memory system, it is also possible to configure such that only one memory bank 400 is provided.

[Configuration Example of Memory Controller]

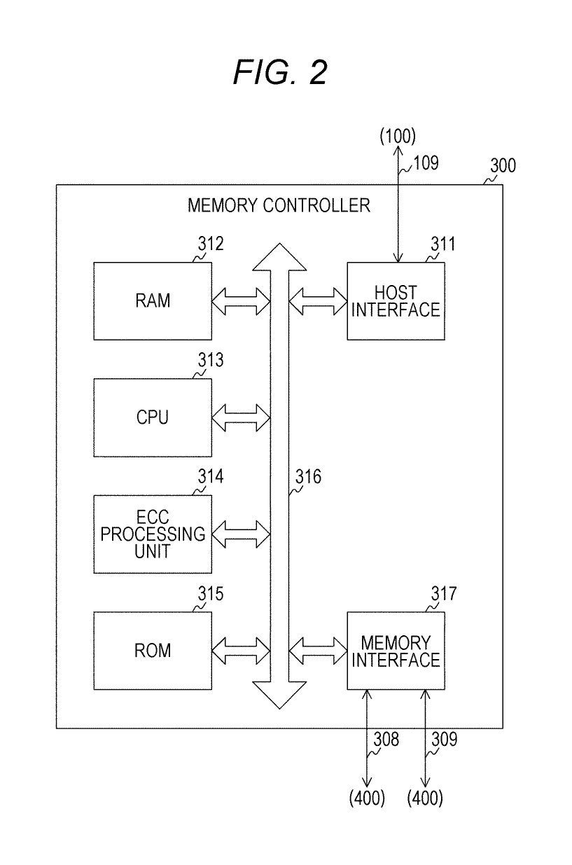

FIG. 2 is a block diagram illustrating a configuration example of the memory controller 300 in the first embodiment. The memory controller 300 is provided with a random access memory (RAM) 312, a central processing unit (CPU) 313, an ECC processing unit 314, and a read only memory (ROM) 315. Also, the memory controller 300 is provided with a host interface 311, a bus 316, and a memory interface 317.

The RAM 312 temporarily holds data required in processing executed by the CPU 313. The CPU 313 controls an entire memory controller 300. The ROM 315 stores a program and the like executed by the CPU 313. The host interface 311 exchanges the data and the command with the host computer 100. The bus 316 is a common path for the RAM 312, the CPU 313, the ECC processing unit 314, the ROM 315, the host interface 311, and the memory interface 317 to exchange the data with one another. The memory interface 317 exchanges the data and the command with the non-volatile memory 410.

A data line and a command address line are wired between the memory interface 317 and the non-volatile memory 410. The memory interface 317 transfers read data or write data to/from the non-volatile memory 400 via the data line, and transfers the command via the command address line. Also, the memory interface 317 performs communication by a half-duplex communication system which cannot simultaneously perform transmission and reception on each of the data line and the command address line. Therefore, the memory interface 317 can transfer only one of the write data and the read data for each request. If both the read data and the write data are simultaneously transferred, both the memory controller 300 and the non-volatile memory 410 fail to receive the data. In other words, the write data and the read data collide with each other on the data line. Therefore, in the first embodiment, the memory controller 300 controls timings to issue the read request and the write request so that the data do not collide with each other.

The ECC processing unit 314 encodes the data to be encoded and decodes the encoded data. In the data encoding, the ECC processing unit 314 encodes the data in a certain unit by adding parity to the data. Also, in the data decoding, the ECC processing unit 314 detects to correct the error of the data using the parity. The ECC processing unit 314 supplies the decoded original data to the host computer 100 via the bus 316.

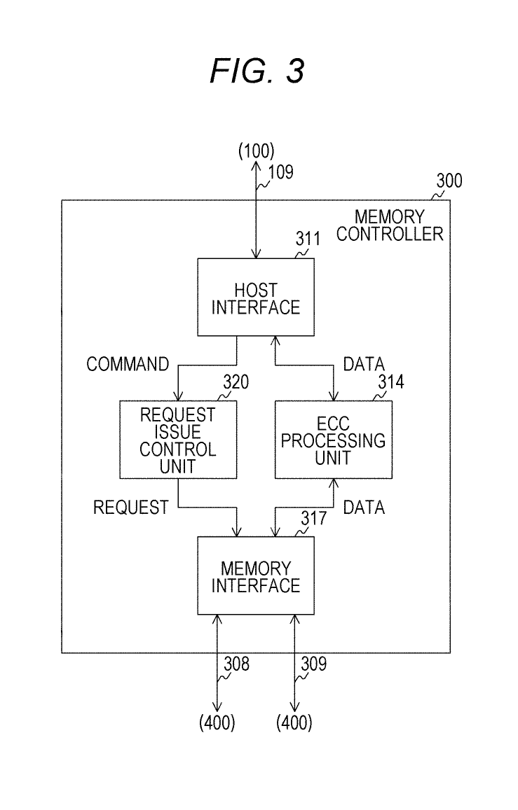

FIG. 3 is a block diagram illustrating a functional configuration example of the memory controller 300 in the first embodiment. The memory controller 300 is provided with the host interface 311, the ECC processing unit 314, the memory interface 317, and a request issue control unit 320. The request issue control unit 320 is realized by the RAM 312 and the CPU 313 in FIG. 2.

The request issue control unit 320 issues the request on the basis of the command. Herein, the request specifies the memory address and requests the access to the non-volatile memory 410, and includes a read request for requesting reading and a write request for requesting writing. The request issue control unit 320 supplies the issued request to the non-volatile memory 410 via the memory interface 317. An access unit by which the request issue control unit 320 accesses the non-volatile memory 410 according to this request may be set in advance by a register (not illustrated) and the like. For example, the access unit is set to two kilobytes (KB), four kilobytes (KB) or the like.

[Configuration Example of Request Issue Control Unit]

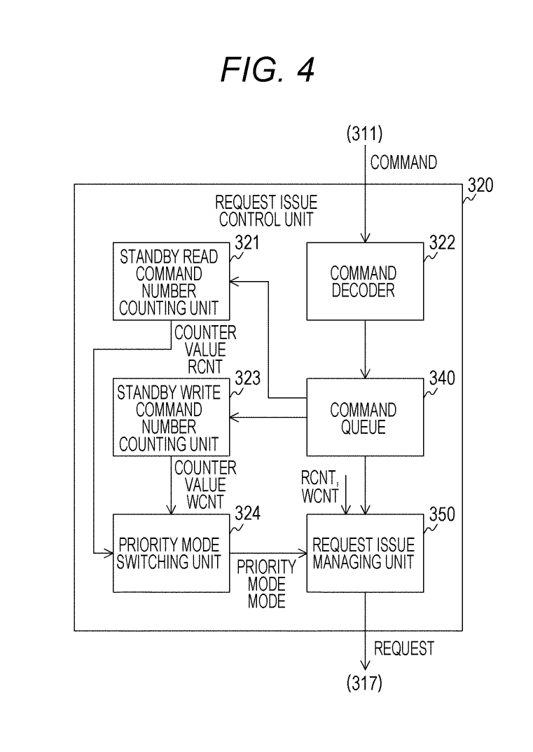

FIG. 4 is a block diagram illustrating a configuration example of the request issue control unit 320 in the first embodiment. The request issue control unit 320 is provided with a standby read command number counting unit 321, a command decoder 322, a standby write command number counting unit 323, a priority mode switching unit 324, a command queue 340, and a request issue managing unit 350.

The command decoder 322 decodes the command. Each time the command decoder 322 decodes the command, this adds the decoded command to the command queue 340.

The command queue 340 holds the command from the command decoder 322. The command queue 340 holds the commands in order of arrival, for example, in a first-in first-out (FIFO) system. These commands are extracted in order of arrival by the request issue managing unit 350. Meanwhile, the command queue 340 is an example of a holding unit recited in claims.

The standby read command number counting unit 321 counts the number of read commands held by the command queue 340 (in other words, standby read command). Herein, it is assumed that the command stores an RW flag indicating whether the command is the write command and the memory address to be accessed. In this RW flag, for example, “1” is set in a case of the write command, and “0” is set in a case of the read command.

The standby read command number counting unit 321 refers to the RW flag of each of the standby commands and obtains the number of write commands from the value. For example, the standby read command number counting unit 321 adds all inverted values of the RW flags of the standby commands, and supplies the added value as a counter value RCNT to the priority mode switching unit 324 and the request issue managing unit 350.

The standby write command number counting unit 323 counts the number of standby write commands. For example, the standby write command number counting unit 323 adds all values of the RW flags of the standby commands and supplies the added value to the priority mode switching unit 324 and the request issue managing unit 350 as a counter value WCNT. Meanwhile, a circuit including the standby read command number counting unit 321 and the standby write command number counting unit 323 is an example of a counting unit recited in claims.

Meanwhile, although the standby read command number counting unit 321 counts the number of commands by adding the inverted values of the RW flags, the number of commands may also be counted by another method. For example, the standby read command number counting unit 321 may increment the counter value RCNT each time the read command is added by the command decoder 322. In this case, each time the read command is extracted by the request issue managing unit 350, the standby read command number counting unit 321 may decrement the counter value RCNT. As for the standby write command number counting unit 323 also, the counter value WCNT may be incremented each time the write command is added and decremented each time the write command is extracted.

The priority mode switching unit 324 switches a priority mode between one of a mode that gives priority to one of the two commands and a mode that gives priority to the other. For example, the priority mode switching unit 324 exclusively switches between a write priority mode that gives priority to the write command and a read priority mode that gives priority to the read command. The priority mode switching unit 324 compares the counter value RCNT and the counter value WCNT with a predetermined threshold N (N is an integer not smaller than two), and switches the priority mode on the basis of a comparison result. For example, N is set to the total number of commands which may be held in the command queue 340 (hereinafter referred to as a “queue size”). The priority mode switching unit 324 switches to the read priority mode in a case where the counter value RCNT is not smaller than N and switches to the write priority mode in a case where the counter value WCNT is not smaller than N. In an initial state, a specific priority mode (for example, the read priority mode) is set. The priority mode switching unit 324 notifies the request issue managing unit 350 of a current priority mode MODE. Meanwhile, the priority mode switching unit 324 is an example of a switching unit recited in claims.

Meanwhile, although the memory controller 300 switches between the mode that gives priority to the write command and the mode that gives priority to the read command, a combination of the commands that take priority is not limited to the write command and the read command. For example, the memory controller 300 may switch between a mode that gives priority to an erase command giving an instruction to set all the bits of the address to a specific value (such as “0”) and a mode that gives priority to other commands.

Also, although the threshold N is set to the queue size, the threshold N may be a value smaller than the queue size as long as this is a value which may exclusively switch between the priority modes. For example, in a case where the queue size is m (m is an integer), if N is set to a value larger than m/2, the priority mode switching unit 324 may exclusively switch between the priority modes.

The request issue managing unit 350 extracts the command from the command queue 340 to process according to the priority mode MODE. In a case of the write priority mode, the request issue managing unit 350 extracts all of the write commands from the command queue 340 in order of arrival, processes these commands, and issues the write request. Then, after extracting all the write commands, the request issue managing unit 350 extracts the read commands from the command queue 340 in order of arrival, processes these commands, and issues the read request.

On the other hand, in a case of the read priority mode, the request issue managing unit 350 extracts all of the read commands from the command queue 340 in order of arrival, processes these commands, and issues the write request. Then, after extracting all the read commands, the request issue managing unit 350 extracts the write commands from the command queue 340 in order of arrival, processes these commands, and issues the write request. Meanwhile the request issue managing unit 350 is an example of a command processing unit recited in claims.

Meanwhile, even if the request issue managing unit 350 processes the commands in order different from command issue order by the host computer 100 as described above, inconvenience does not occur because access order to the same address is managed by the host computer 100. For example, when the host computer 100 writes data for saving at a certain address by the write command, this does not issue the read command specifying the address until this receives a write response.

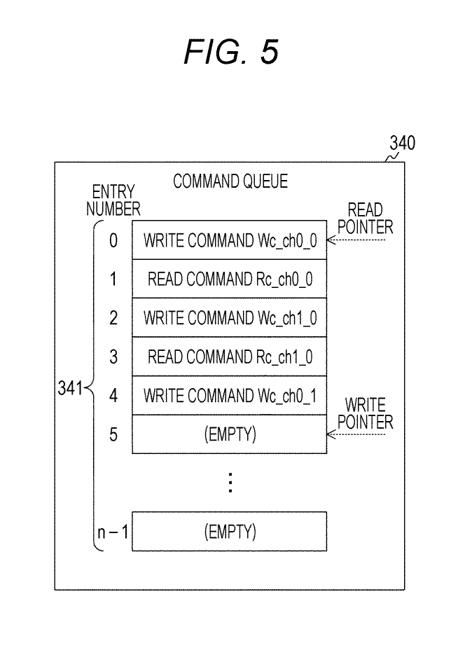

FIG. 5 is a view illustrating a configuration example of the command queue 340 in the first embodiment. As illustrated in this drawing, the command queue 340 is provided with a command holding unit 341 provided with a plurality of entries. An entry number for identifying the entry is allocated to each entry, and one command is held in each entry. Herein, a read pointer, a write pointer, and the number of commands are held in a register (not illustrated) which may be commonly accessed by the command decoder 322 and the request issue control unit 320. The read pointer indicates a position of the entry from which the command is to be extracted and the write pointer indicates a position of the entry to which the command is to be added. The number of commands indicates the number of commands held in the command queue 340.

The command decoder 322 determines whether the number of commands is equal to the queue size (that is, whether buffer is full) when adding the command. If the buffer is full, the command decoder 322 discards the command, for example, and returns a notification of buffer full to the host computer 100. On the other hand, in a case where the buffer is not full, the command decoder 322 writes the command in the entry indicated by the write pointer. Then, the command decoder 322 updates (for example, increments) the write pointer and increments the number of commands.

Also, if the number of commands is not “0” (that is, buffer is empty), the request issue control unit 320 refers to the RW flag of the command of the entry indicated by the read pointer, and determines whether the command is the command to be extracted. For example, in the read priority mode, the request issue control unit 320 makes the read command the target to be extracted until all the read commands are extracted (that is, the counter value RCNT reaches 0). If this is not the command to be extracted, the entry number of the read pointer is decremented and the RW flag of the command of this entry number is referred to. In this manner, the request issue control unit 320 searches for the command to be extracted while following the entries from the read pointer in reverse order of the arrival order and extracts the command to be extracted.

In a case where the command is extracted from the entry different from the entry indicated by the read pointer, the request issue control unit 320 moves each of the commands of the entries subsequent to the entry from which the command is extracted one by one in a direction of smaller entry number. Then, the request issue control unit 320 updates (for example, increments) the read pointer and decrements the number of commands.

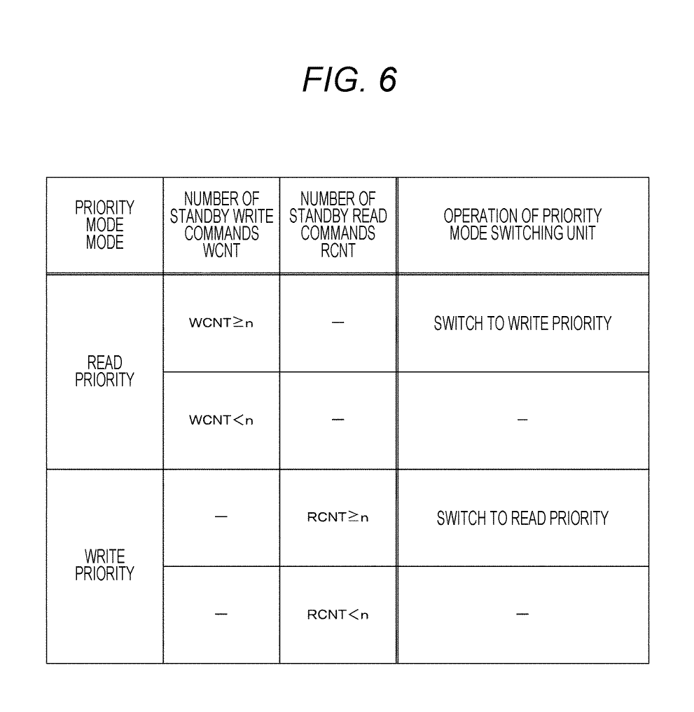

FIG. 6 is a view illustrating an example of operation of the priority mode switching unit 324 in the first embodiment. In the read priority mode, if the number of standby write commands WCNT becomes n or larger, the priority mode switching unit 324 switches to the write priority mode. On the other hand, in the write priority mode, if the number of standby read commands RCNT becomes N or larger, the priority mode switching unit 324 switches to the read priority mode.

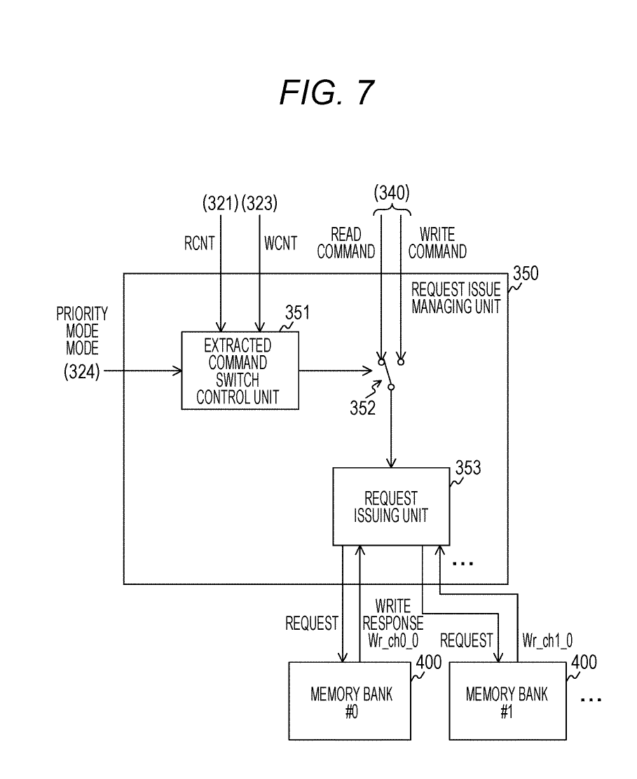

FIG. 7 is a block diagram illustrating a configuration example of the request issue managing unit 350 in the first embodiment. The request issue managing unit 350 is provided with an extracted command switch control unit 351, an extracting unit 352, and a request issuing unit 353.

The extracted command switch control unit 351 switches a type of the command extracted from the command queue 340 by a switching signal. Herein, the switching signal is a signal instructing the extracting unit 352 of the type of the command to be extracted from the command queue 340. For example, in a case of instruction to extract the read command, the switching signal is set to a high level, and in a case of instruction to extract the write command, the switching signal is set to a low level.

The extracted command switch control unit 351 refers to the counter value RCNT in the read priority mode and determines whether there is the standby read command in the command queue 340. In a case where there is the standby read command, the extracted command switch control unit 351 sets the switching signal to the high level to allow extraction of the read command. On the other hand, in a case where there is no standby read command, the extracted command switch control unit 351 sets the switching signal to the low level to allow extraction of the write command.

Also, the extracted command switch control unit 351 refers to the counter value WCNT in the write priority mode and determines whether there is the standby write command in the command queue 340. In a case where there is the standby write command, the extracted command switch control unit 351 sets the switching signal to the low level to allow extraction of the write command. On the other hand, in a case where there is no standby write command, the extracted command switch control unit 351 sets the switching signal to the high level to allow extraction of the read command.

By this control, in the write priority mode, all the write commands are continuously extracted from the command queue 340 in sequence, and the read commands are extracted in sequence after all the write commands are extracted. Also, in the read priority mode, all the read commands are continuously extracted from the command queue 340 in sequence, and the write commands are extracted in sequence after all the read commands are extracted.

The extracting unit 352 extracts the command from the command queue 340 according to the switching signal. The extracting unit 352 supplies the extracted command to the request issuing unit 353.

The request issuing unit 353 processes the extracted command and issues the request. When issuing the request, the request issuing unit 353 determines whether there is no uncompleted access control regarding a memory area (memory bank and the like) to be accessed, and issues the request after the access control is completed. For example, in a case of issuing the write request regarding the memory area which issues the read request last time, the request issuing unit 353 issues the write request after the reading of the last read data is completed. As a result, the collision of the write data with the read data on the data line is prevented. Also, in a case of issuing the request regarding the memory area which issues the write request last time, the request issuing unit 353 issues the request after receiving the write response to the write request. Herein, the write response notifies a fact that the non-volatile memory 410 succeeds in writing the write data.

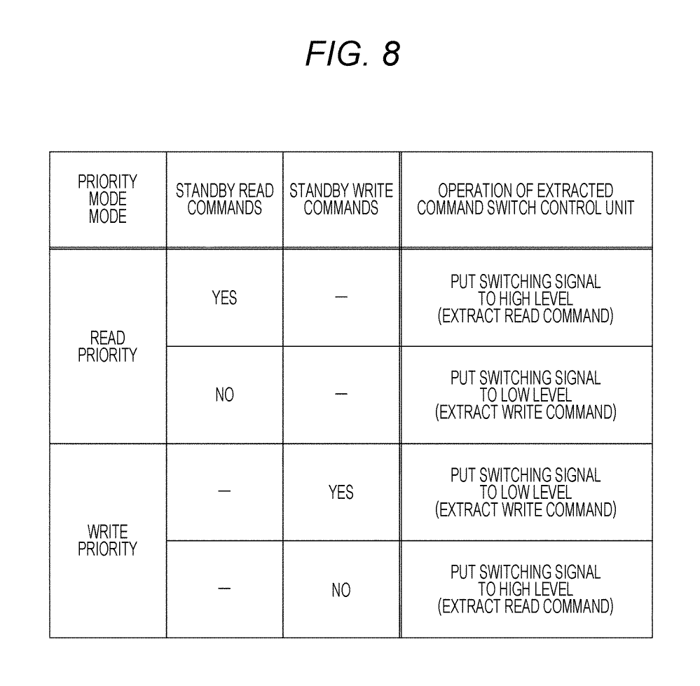

FIG. 8 is a view illustrating an example of operation of the extracted command switch control unit 351 in the first embodiment. When there is the standby read command in the read priority mode, the extracted command switch control unit 351 sets the switching signal to the high level to allow extraction of the read command. On the other hand, in a case where there is no standby read command, the extracted command switch control unit 351 sets the switching signal to the low level to allow extraction of the write command.

Also, if there is the standby write command in the write priority mode, the extracted command switch control unit 351 sets the switching signal to the low level to allow the extraction of the write command. On the other hand, in a case where there is no standby write command, the extracted command switch control unit 351 sets the switching signal to the high level to allow extraction of the read command.

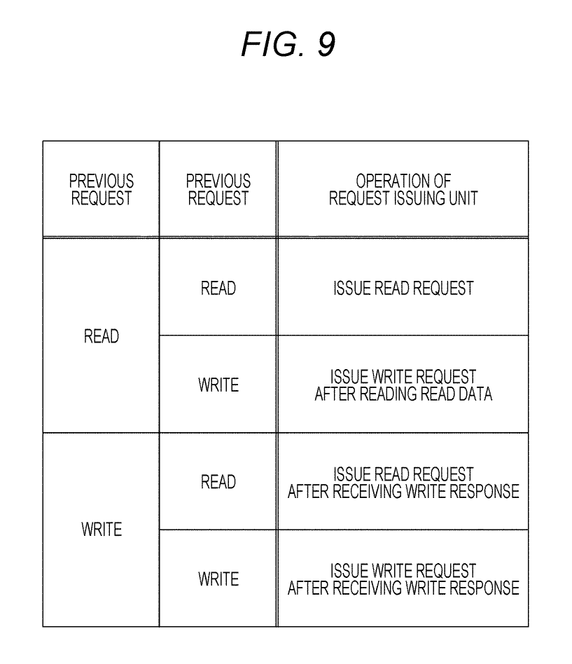

FIG. 9 is a view illustrating an example of operation of the request issuing unit 353 in the first embodiment. In a case where the read request is issued last time regarding a certain memory area and a current request is the write request, the request issuing unit 353 issues the write request after the reading of the read data is completed. Also, in a case where the write request is issued last time, the request issuing unit 353 issues the current request after receiving the write response to the write request.

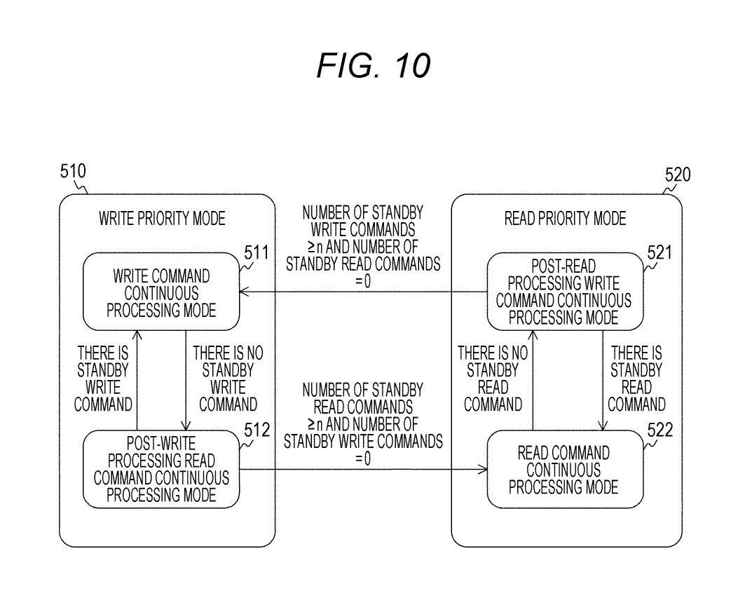

FIG. 10 is an example of a state transition diagram of the memory controller 300 in the first embodiment. A state of the memory controller 300 includes a write priority mode 510 and a read priority mode 520. Also, the write priority mode 510 includes a write command continuous processing mode 511 and a post-write processing read command continuous processing mode 512. The read priority mode 520 includes a post-read processing write command continuous processing mode 521 and a read command continuous processing mode 522.

An initial state is set, for example, to the read command continuous processing mode 522. In this read command continuous processing mode 522, the memory controller 300 continuously extracts only the read commands from the command queue 340 in order of arrival and processes them. When there is no more standby read command in the read command continuous processing mode 522, the memory controller 300 shifts to the post-read processing write command continuous processing mode 521.

In the post-read processing write command continuous processing mode 521, the memory controller 300 continuously extracts only the write commands from the command queue 340 in order of arrival and processes them. If the read command is added to the command queue 340 in the post-read processing write command continuous processing mode 521, the memory controller 300 shifts to the read command continuous processing mode 522. Also, if the number of standby write commands becomes equal to or larger than n, the memory controller 300 shifts to the write command continuous processing mode 511. Herein, in a case where n is equal to a buffer size, the number of standby read commands when the number of standby write commands is n is 0.

In the write command continuous processing mode 511, the memory controller 300 continuously extracts only the write commands from the command queue 340 in order of arrival and processes them. When there is no more standby write command in the write command continuous processing mode 511, the memory controller 300 shifts to the post-write processing read command continuous processing mode 512.

In the post-write processing read command continuous processing mode 512, the memory controller 300 continuously extracts only the read commands from the command queue 340 in order of arrival and processes them. If the write command is added to the command queue 340 in the post-write processing read command continuous processing mode 512, the memory controller 300 shifts to the write command continuous processing mode 511. Also, if the number of standby read commands becomes equal to or larger than n, the memory controller 300 shifts to the read command continuous processing mode 522. Herein, in a case where n is equal to the buffer size, the number of standby write commands when the number of standby read commands is n is 0.

[Configuration Example of Non-Volatile Memory]

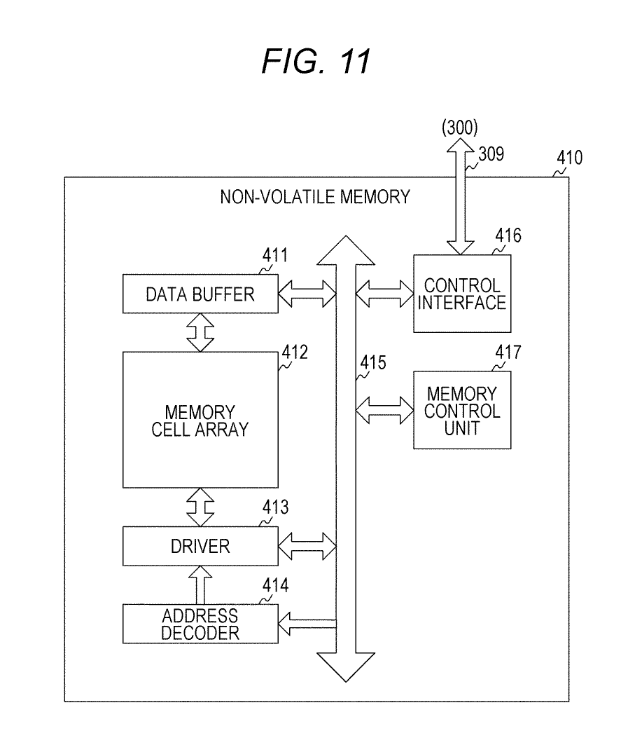

FIG. 11 is a block diagram illustrating a configuration example of the non-volatile memory 410 in the first embodiment. The non-volatile memory 410 is provided with a data buffer 411, a memory cell array 412, a driver 413, an address decoder 414, a bus 415, a control interface 416, and a memory control unit 417.

The data buffer 411 holds the write data and the read data in access unit under the control of the memory control unit 417. The memory cell array 412 is provided with a plurality of memory cells arranged in a matrix pattern. As each memory cell, a non-volatile storage element such as a ReRAM is used.

The driver 413 writes the data in or reads the data from the memory cell selected by the address decoder 414. The address decoder 414 analyzes the address specified by the request to select the memory cell corresponding to the address. The bus 415 is a common path for the data buffer 411, the memory cell array 412, the address decoder 414, the memory control unit 417, and the control interface 416 to exchange the data with one another. The control interface 416 is an interface for the memory controller 300 and the non-volatile memory 410 to exchange the data and request with each other.

The memory control unit 417 controls the driver 413 and the address decoder 414 to write or read the data. When receiving the write request, the memory control unit 417 allows the data buffer 411 to hold the write data. Also, the memory control unit 417 supplies the memory address specified by the write request to the address decoder 414. If the memory cell is selected by the address decoder 414, the memory control unit 417 controls the driver 413 to write the data in the memory cell.

Then, the memory control unit 417 controls the driver 413 to read the data from the memory cell in which the data is written. The memory control unit 417 verifies the data which is read against the write data held in the data buffer 411. The memory control unit 417 generates the write response when the verification is successful and supplies the same to the memory controller 300 via the control interface 416.

Also, when receiving the read request, the memory control unit 417 controls the address decoder 414 and the driver 413 to output the read data to the memory controller 300.

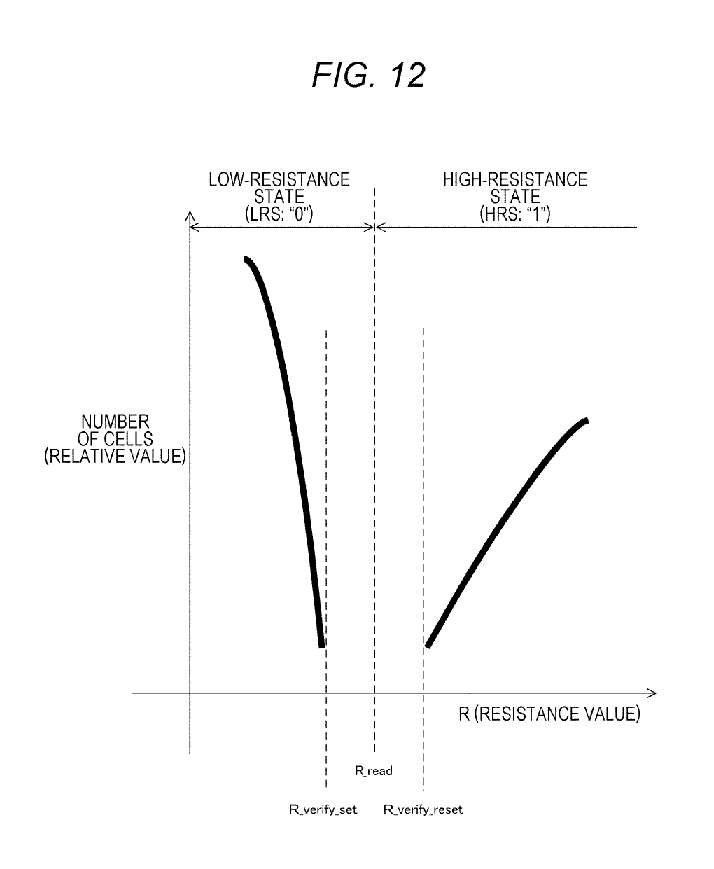

FIG. 12 is a view illustrating an example of resistance distribution of a variable resistance element of the ReRAM in the first embodiment. In this drawing, the abscissa represents the resistance value, and the ordinate represents relative distribution of the number of cells by a relative value. A resistance state of the variable resistance element is roughly divided into two distributions at a predetermined threshold R_read as a boundary. A state in which the resistance value is lower than the threshold R_read is referred to as a low-resistance state (LRS), and a state in which the resistance value is higher than the threshold R_read is referred to as a high-resistance state (HRS). By applying voltage to the variable resistance element, the non-volatile memory 410 may reversibly change the resistance state thereof to rewrite the memory cell. Since the resistance state is maintained even when voltage application to the memory cell is stopped, the ReRAM may serve as the non-volatile memory.

Also, any one of logical values “0” and “1” is associated with each of LRS and HRS of the variable resistance element. For example, the logical value “0” is associated with LRS and the logical value “1” is associated with HRS. The logical values “0” and “1” are arbitrarily associated with each state.

If voltage not smaller than a certain level is applied to a HRS memory cell, the memory cell makes the transition to LRS (“0”). This operation is hereinafter referred to as “setting” operation. On the other hand, when voltage in an opposite direction is applied to an LRS memory cell, the memory cell makes the transition to HRS (“1”). This operation is hereinafter referred to as “reset” operation.

In verification, a threshold different from the threshold R_read is used. For example, when reading the data from the set memory cell, the memory control unit 417 sets the threshold to R_verify_set lower than the threshold R_read. On the other hand, when reading the data from the reset memory cell, the memory control unit 417 sets the threshold to R_verify_reset higher than the threshold R_read.

[Operation Example of Memory Controller]

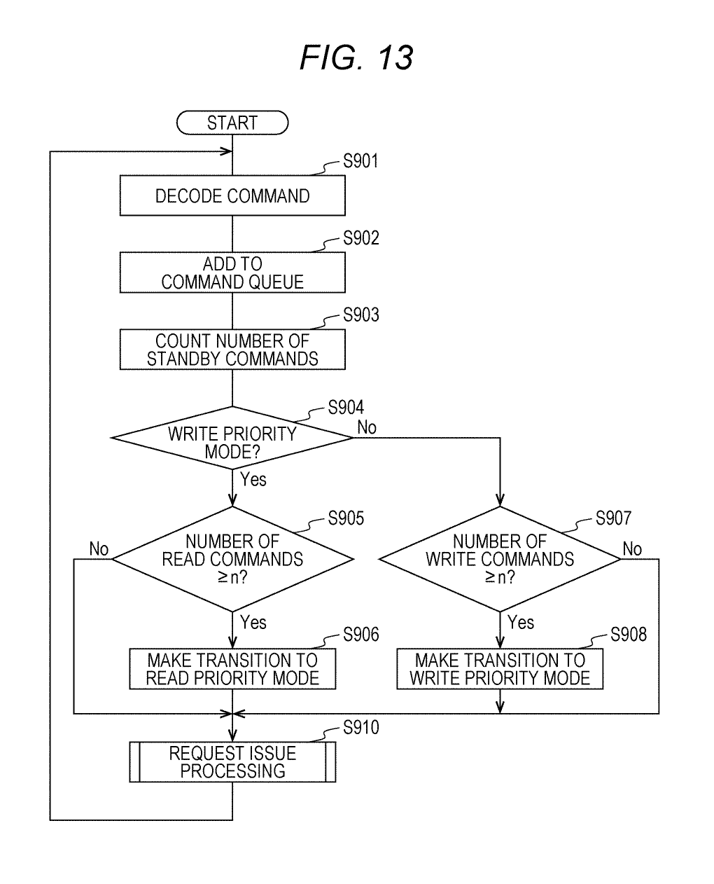

FIG. 13 is a flowchart illustrating an example of operation of the memory controller 300 in the first embodiment. This operation starts, for example, when the memory controller 300 is powered on. The memory controller 300 decodes the command from the host computer 100 (step S901) and adds the same to the command queue 340 (step S902). Also, the memory controller 300 counts each of the number of standby read commands and the number of standby write commands (step S903).

Then, the memory controller 300 determines whether the current priority mode is the write priority mode (step S904). In a case of the write priority mode (step S904: Yes), the memory controller 300 determines whether the number of standby read commands is n or larger (step S905). In a case where the number of read commands is not smaller than n (step S905: Yes), the memory controller 300 makes the transition to the read priority mode (step S906).

In a case where the current priority mode is the read priority mode (step S904: No), the memory controller 300 determines whether the number of standby write commands is not smaller than n (step S907). In a case where the number of write commands is equal to or larger than n (step S907: Yes), the memory controller 300 makes the transition to the write priority mode (step S908).

In a case where the number of read commands is smaller than n (step S905: No) or after step S906, the memory controller 300 executes request issue processing (step S910). Also, in a case where the number of write commands is smaller than n (step S907: No) or after step S908, the memory controller 300 executes the request issue processing (step S910). After step S910, the memory controller 300 repeats step S901 and subsequent steps.

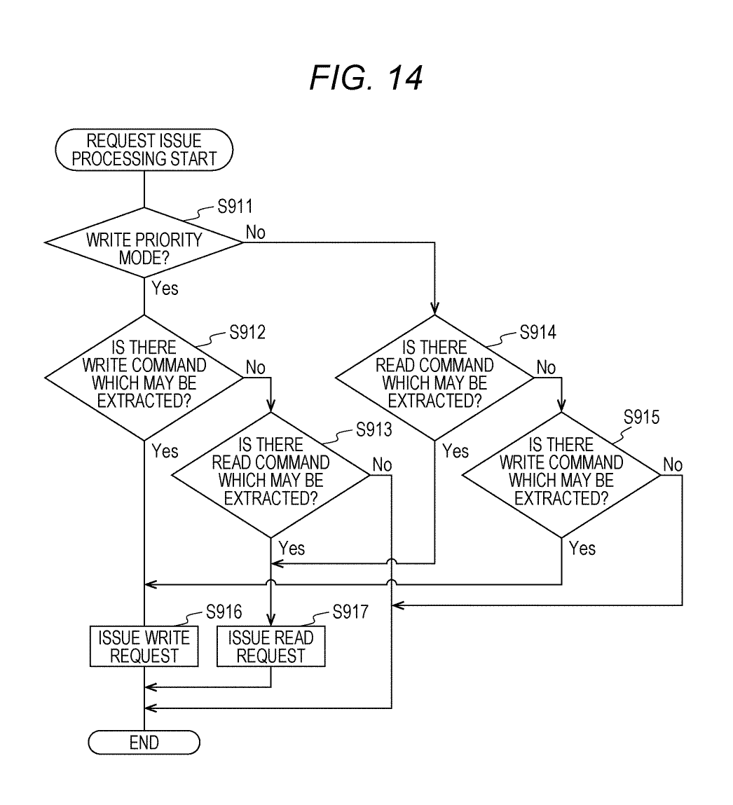

FIG. 14 is a flowchart illustrating an example of the request issue processing in the first embodiment. The memory controller 300 determines whether the current priority mode is the write priority mode (step S911). In the case of the write priority mode (step S911: Yes), the memory controller 300 determines whether there is the write command which may be extracted in the command queue 340 (step S912). For example, in the memory area to be accessed, in a case where the reading of the read data is not completed or the writing of the write data is not completed, the write command is extracted after they are completed.

In a case where there is the write command which may be extracted (step S912: Yes), the memory controller 300 extracts the write command and processes the same, and issues the write request (step S916).

On the other hand, in a case where there is no write command which may be extracted (step S912: No), the memory controller 300 determines whether there is the read command which may be extracted in the command queue 340 (step S912). For example, in the memory area to be accessed, in a case where the writing of the write data is not completed, the read command is extracted after this is completed.

In a case where there is the read command which may be extracted (step S913: Yes), the memory controller 300 extracts the read command and processes the same, and issues the read request (step S917).

In a case where there is no read command which may be extracted (step S913: No), or after step S916 or S917, the memory controller 300 ends the request issue processing.

Also, in a case of the read priority mode (step S911: No), the memory controller 300 determines whether there is the read command which may be extracted in the command queue 340 (step S914). In a case where there is the read command which may be extracted (step S914: Yes), the memory controller 300 executes step S917. In a case where there is no read command which may be extracted (step S914: No), the memory controller 300 determines whether there is the write command which may be extracted (step S915). In a case where there is the write command which may be extracted (step S915: Yes), the memory controller 300 executes step S916. In a case where there is no write command which may be extracted (step S915: No), the memory controller 300 ends the request issue processing.

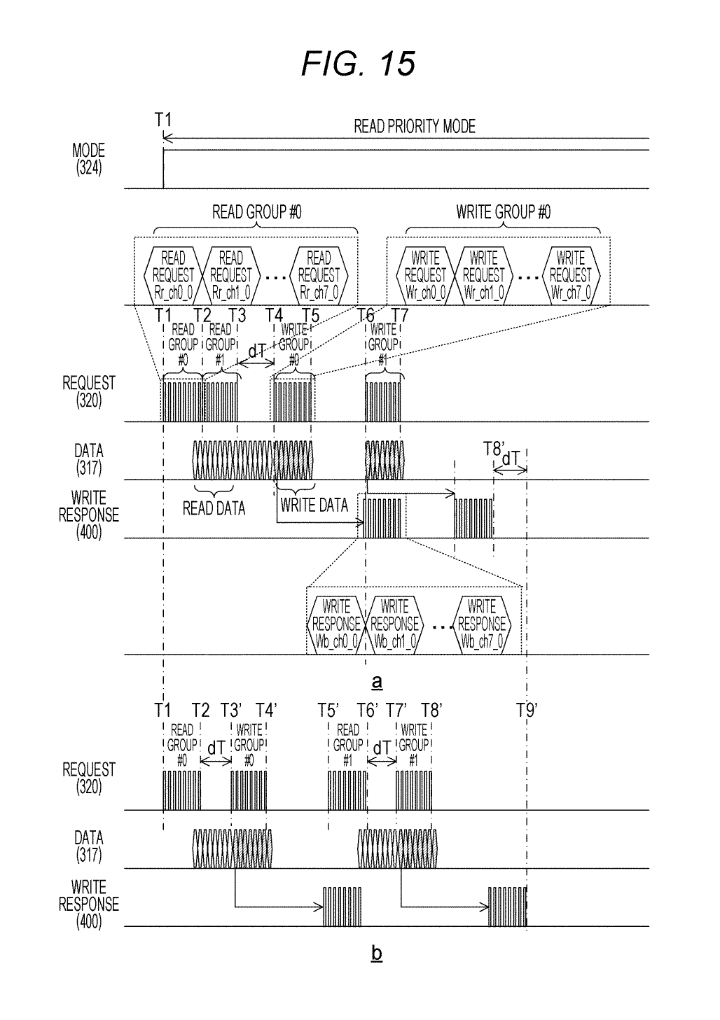

FIG. 15 is a timing chart illustrating an example of the operation of the memory controller 300 in the first embodiment. a of this drawing is a timing chart in the read priority mode. For example, suppose that the host computer 100 issues the read command by specifying the logical addresses corresponding to memory banks ch0 to ch7, and then issues the write command by specifying the logical addresses corresponding to the memory banks. Then, suppose that the host computer 100 issues the read command by specifying the logical addresses corresponding to the memory banks ch0 to ch7 again, and then issues the write command by specifying the logical addresses corresponding to the memory banks. Also, suppose that the read priority mode is set in the memory controller 300 at timing T1.

The memory controller 300 first extracts the read command from the command queue 340. Then, the memory controller 300 processes the read command and issues read requests Rr_ch0_0 to Rr_ch7_0 specifying the memory addresses of the memory banks ch0 to ch7. Since the read command is held in the command queue 340 at timing T2 immediately after issue thereof, the memory controller 300 determines whether the read command may be processed. Since the reading of the read data is completed regarding the memory bank ch0 at timing T2, the memory controller 300 may process the read command at that point in time. The memory controller 300 issues the next read request Rr_ch0_1 specifying the memory address of the memory bank ch0. Subsequently, the memory controller 300 sequentially issues the read requests Rr_ch1_1 to Rr_ch7_1 specifying the memory addresses of the memory banks ch1 to ch7, respectively.

At timing T3 immediately after the issue of the read requests Rr_ch0_1 to Rr_ch7_1, there is no read command which may be processed in the command queue 340. Therefore, the memory controller 300 determines whether the write command in the command queue 340 may be processed. At timing T4 at which the reading of the read data is completed, processing of the write command becomes possible. After the timing T4, the memory controller 300 extracts the write command and sequentially issues the write requests Wr_ch0_0 to Wr_ch7_0 specifying the memory addresses of the memory banks ch0 to ch7, respectively.

At timing T5 immediately after issue of the write requests Wr_ch0_0 to Wr_ch7_0, there is no read command which may be processed in the command queue 340. Therefore, the memory controller 300 determines whether the write command in the command queue 340 may be processed. At timing T6 at which the memory controller 300 receives the write response regarding the memory bank ch0, it becomes possible to process the write command. At this timing T6, the memory controller 300 extracts the write command and issues the write request Wr_ch0_1 specifying the memory address of the memory bank ch0. Subsequently, the memory controller 300 sequentially issues the write requests Wr_ch1_1 to Wr_ch7_1 specifying the memory addresses of the memory banks ch1 to ch7, respectively. Reception of the write responses to these requests is completed at timing T8.

Also, in FIG. 15, a read group #0 is a set of the read requests Rr_ch0_0 to Rr_ch7_0, and a read group #1 is a set of the read requests Rr_ch0_1 to Rr_ch7_1. A write group #0 is a set of the write requests Wr_ch0_0 to Wr_ch7_0, and a write group #1 is a set of the write requests Wr_ch0_1 to Rr_ch7_1.

b of FIG. 15 is a timing chart illustrating operation of the memory controller in a comparative example in which the commands are processed in order of arrival. At timing T1, the memory controller 300 sequentially issues the read requests Rr_ch0_0 to Rr_ch7_0. At timing T2 immediately after the completion of the issue, it is necessary to issue the write request next in order of arrival, but the reading of the read data is completed at timing T3′. Therefore, after timing T3′, the memory controller 300 sequentially issues the write requests Wr_ch0_0 to Wr_ch7_0. In this manner, by issuing the write request after the reading of the read data is completed, collision of the read data with the write data may be avoided. Other way round, when issuing the write request after the read request, the memory controller 300 needs make the issue of the write request stand by until the reading of the read data is completed.

At the timing T4′ immediately after the write requests Wr_ch0_0 to Wr_ch7_0 are issued, it is necessary to issue the read request next in order of arrival, but the memory controller 300 receives the write response of the memory bank ch0 at timing T5′. Therefore, after timing T5′, the memory controller 300 sequentially issues the read requests Rr_ch0_1 to Rr_ch7_1. At timing T6′ immediately after the issue is completed, it is necessary to issue the write request next in order of arrival, but the reading of the read data is completed at timing T7′. Therefore, after timing T7′, the memory controller 300 sequentially issues the write requests Wr_ch0_1 to Wr_ch7_1. The reception of the write responses to these requests is completed at timing T9′.

Comparing a and b of FIG. 15, in a, only one write request is issued after the read request. For example, the memory controller 300 issues the next write request at timing T4 dT after the issue of the read request at timing T3, On the other hand, in b of this drawing, two write requests are issued after the read request. For example, the memory controller 300 issues the next write request at timing T3′ dT after the issue of the read request at timing T2′. Also, the memory controller 300 issues the next write request at the timing T7′ dT after the issue of the read request at timing T6′. Therefore, timing T8 at which processing of a series of commands is completed in a of this drawing is earlier by dT than timing T9′ at which the processing is completed in b of this drawing.

In this manner, in the read priority mode, since the read commands are processed continuously until there is no more read command in the command queue 340, it is less likely that the issue of the write request stands by until the reading of the read data is completed. Therefore, it is possible to improve an access speed as compared with a case where the commands are processed in order of arrival.

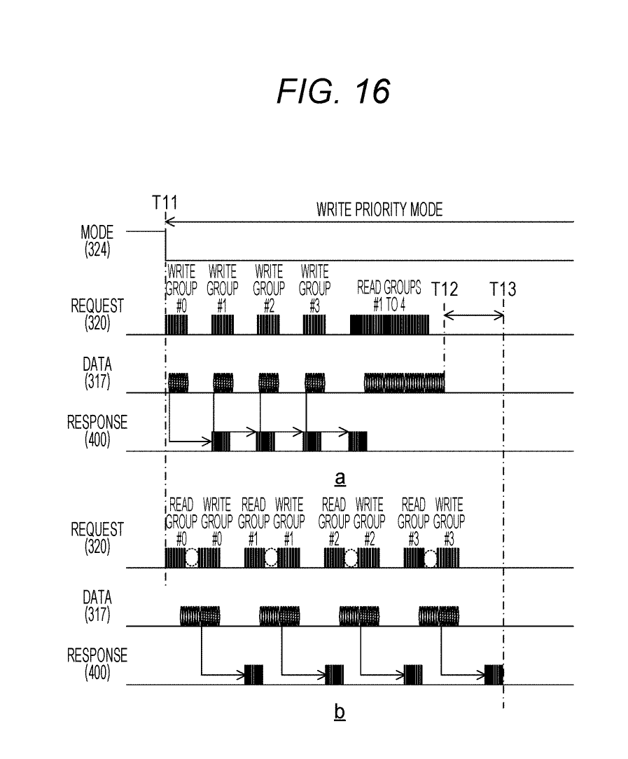

FIG. 16 is a flowchart illustrating an example of the operation of the memory controller in the first embodiment. a of this drawing is a timing chart in the write priority mode. When it is switched to the write priority mode at timing T11, the memory controller 300 sequentially issues the write requests in the write groups #0 to #3. The memory controller 300 sequentially issues the read requests in the read groups #0 to #3 when there is no more standby write command by the issue of these write requests.

b of FIG. 16 is a timing chart illustrating operation of the memory controller in a comparative example in which the commands are processed in order of arrival. At timing T11, the memory controller 300 sequentially issues the read requests in the read group #0, and then sequentially issues the write requests in the write group #0 Then, the requests in the write group #1, the read group #2, the write group #2, the read group #3, and the write group #3 are sequentially issued in this order.

Comparing a and b of FIG. 16, there is no write request issued after the read request in a. On the other hand, in b of this drawing, there are four write requests issued after the read request. Therefore, in a of this drawing, timing T12 at which processing of a series of commands is completed is earlier than timing T13 at which a series of processing is completed in this drawing.

As illustrated in FIGS. 15 and 16, the access speed is improved in both the read priority mode and the write priority mode.

As described above, according to the first embodiment of the present technology, since the priority mode is switched on the basis of the number of standby commands and all the commands having priority are extracted from the queue, the memory controller 300 may continuously issue the same type of requests. As a result, when issuing the write request after the read request, total time during which the write request stands by until the reading of the read data is completed is shortened, and the access speed may be improved.

### 2. Second Embodiment

In the first embodiment described above, the memory controller 300 counts the number of commands held in the command queue 340; however, this may count the number of commands extracted from a command queue 340 and compare the same with a threshold. A memory controller 300 according to the second embodiment is different from that of the first embodiment in that this counts the number of commands extracted from the command queue 340.

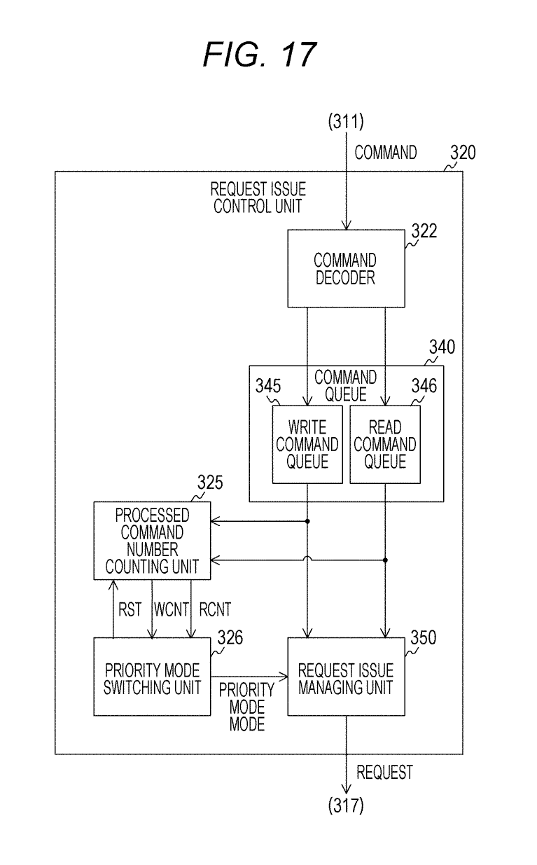

FIG. 17 is a block diagram illustrating a configuration example of a request issue control unit 320 in the second embodiment. The request issue control unit 320 of the second embodiment is different from that of the first embodiment in including a processed command number counting unit 325 in place of a standby read command number counting unit 321, a standby write command number counting unit 323, and a priority mode switching unit 324. Also, the request issue control unit 320 of the second embodiment is different from that of the first embodiment in including a priority mode switching unit 326 in place of the priority mode switching unit 324. Also, the command queue 340 of the second embodiment is provided with a write command queue 345 and a read command queue 346. Queue sizes of the command queues may be of the same value or different values.

The write command queue 345 holds write commands in a FIFO system. The read command queue 346 holds read commands in the FIFO system. A write pointer, a read pointer, and the number of commands are held in a register (not illustrated) for each of the write command queue 345 and the read command queue 346. A command decoder 322 and a request issue managing unit 350 of the second embodiment control the write pointer, the read pointer, and the number of commands for each command queue in the manner similar to that in the first embodiment in command addition and extraction. Meanwhile, the write command queue 345 is an example of a write command holding unit recited in claims and the read command queue 346 is an example of a read command holding unit recited in claims.

The processed command number counting unit 325 counts the number of the read commands and that of the write commands extracted from when a priority mode is switched. The processed command number counting unit 325 increments a counter value RCNT each time the read command is extracted from the read command queue 346 and increments a counter value WCNT each time the write command is extracted from the write command queue 345. Then, the processed command number counting unit 325 supplies the counter values to the priority mode switching unit 326. Meanwhile, the processed command number counting unit 325 is an example of a counting unit recited in claims.

Each time the priority mode is switched, the priority mode switching unit 326 sets the counter values RCNT and WCNT to initial values by a reset signal RST. Also, when the counter value RCNT becomes equal to or larger than a predetermined threshold Nr in a read priority mode, the priority mode switching unit 326 switches to a write priority mode. On the other hand, when the counter value WCNT becomes equal to or larger than a predetermined threshold Nw in the write priority mode, the priority mode switching unit 326 switches to the read priority mode. The thresholds Nr and Nw may be the same value or different values.

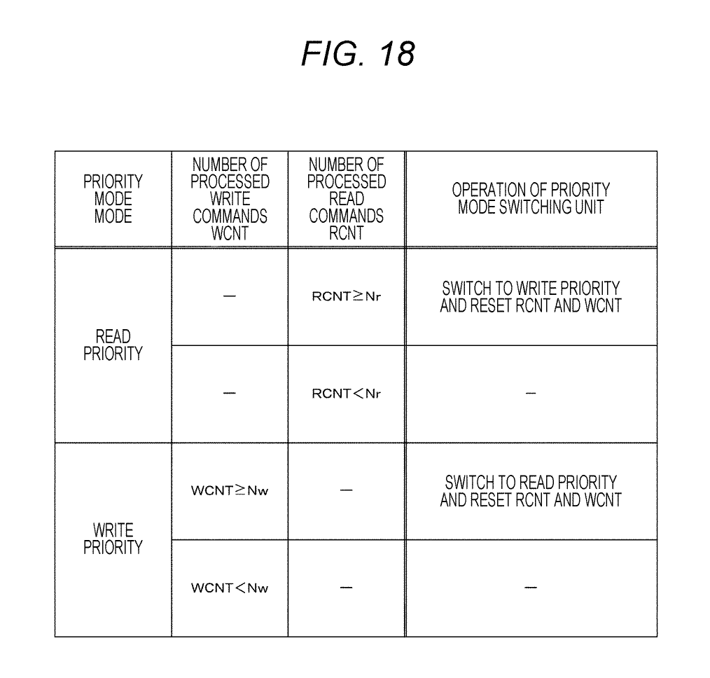

FIG. 18 is a view illustrating an example of operation of the priority mode switching unit 326 in the second embodiment. When the number of processed read commands (RCNT) becomes equal to or larger than the threshold Nr in the read priority mode, the priority mode switching unit 326 switches to the write priority mode and resets the counter value. On the other hand, when the number of processed write commands (WCNT) becomes equal to or larger than the threshold Nw in the write priority mode, the priority mode switching unit 326 switches to the read priority mode and resets the counter value.

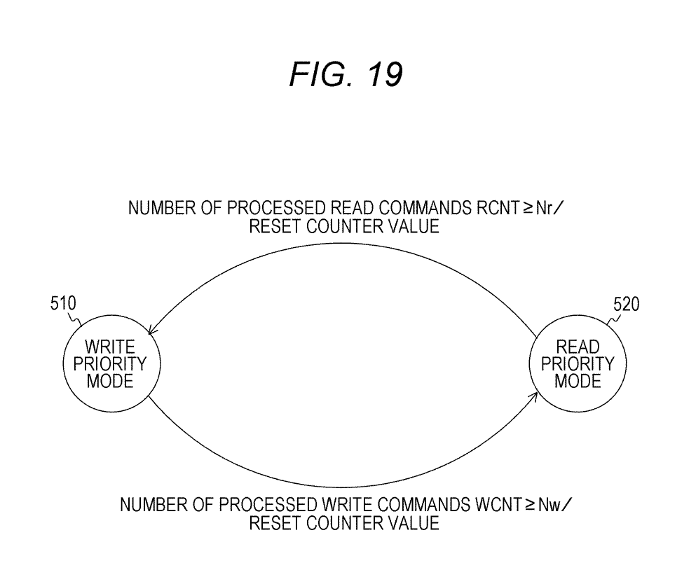

FIG. 19 is an example of a state transition diagram of the memory controller 300 in the second embodiment. When the number of processed read commands (RCNT) becomes equal to or larger than the threshold Nr in the read priority mode 520, the memory controller 300 makes the transition to the write priority mode 510 and resets the counter value. On the other hand, when the number of processed write commands (WCNT) becomes equal to or larger than the threshold Nw in the write priority mode 510, the memory controller 300 makes the transition to the read priority mode 520 and resets the counter value.

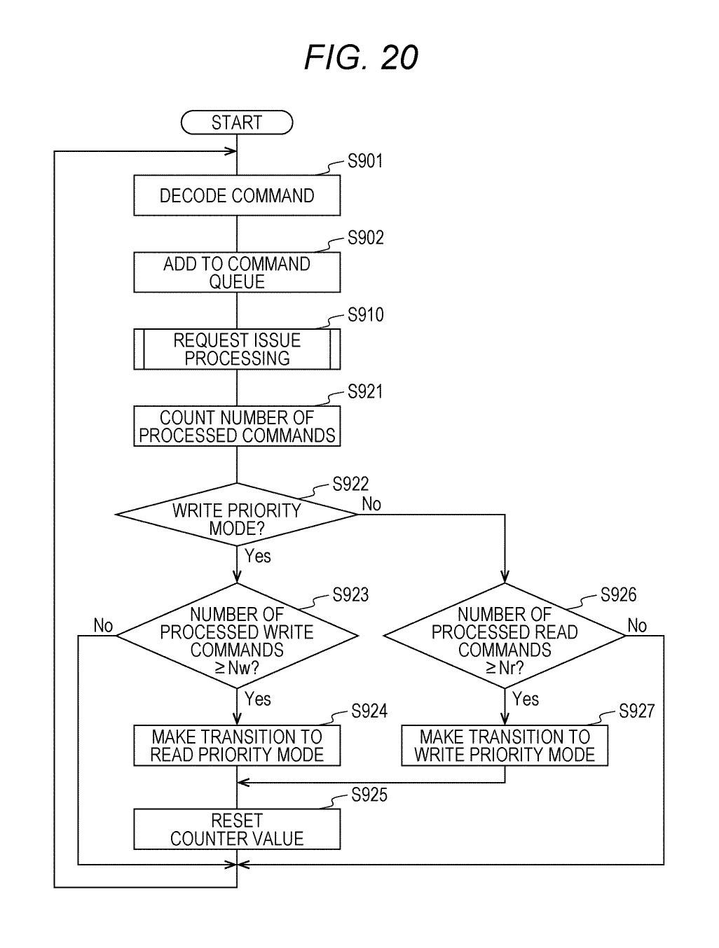

FIG. 20 is a view illustrating an example of operation of the memory controller 300 in the second embodiment. The operation of the memory controller 300 in a third embodiment is different from that of the first embodiment in that steps S921 to S927 are executed in place of steps S903 to S908.

The memory controller 300 adds the command to the command queue 340 (step S902), and performs a request issue processing (step S910). Also, the memory controller 300 counts the number of processed commands (step S921). Then, the memory controller 300 determines whether the current priority mode is the write priority mode (step S922).

In a case of the write priority mode (step S922: Yes), the memory controller 300 determines whether the number of processed write commands WCNT is not smaller than Nw (step S923). In a case where WCNT is equal to or larger than Nw (step S923: Yes), the memory controller 300 makes the transition to the read priority mode (step S924).

On the other hand, in a case of the read priority mode (step S922: No), the memory controller 300 determines whether the number of processed read commands RCNT is not smaller than Nr (step S926). In a case where RCNT is not smaller than Nr (step S926: Yes), the memory controller 300 makes the transition to the write priority mode (step S927). After step S924 or S927, the memory controller 300 resets the counter value (step S925). In a case where WCNT is smaller than Nw (step S923: No), the RCNT is smaller than Nr (step S926: No), or after step S925, the memory controller 300 repeats step S901 and subsequent steps.

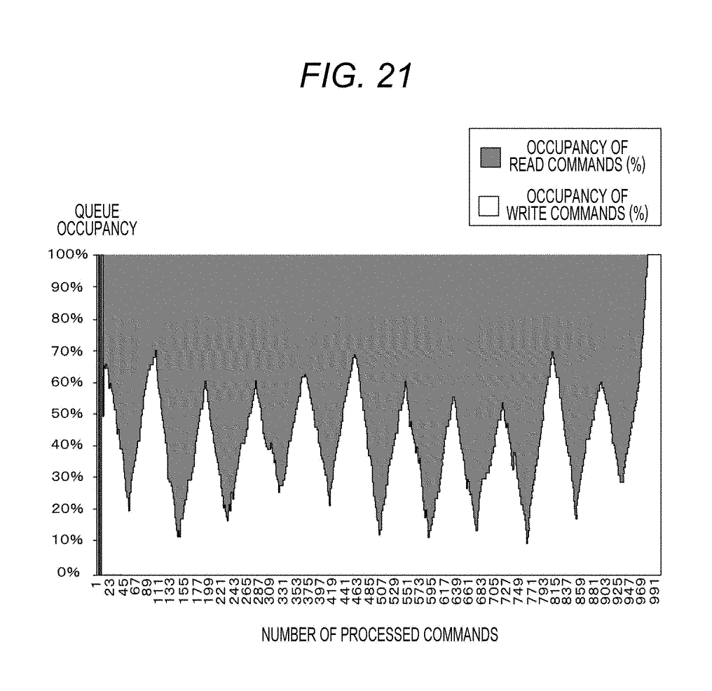

FIG. 21 is a graph representing an example of change in queue occupancy in the second embodiment. The ordinate in this drawing represents a ratio of the write commands in an entire command queue 340. The abscissa in this drawing represents the number of processed commands.

Also, the threshold Nr to be compared with the number of processed read commands RCNT is 45, and the threshold Nr to be compared with the number of processed write commands WCNT is 40. Also, a command size is represented in kilobyte (KB). As a result, the memory controller 300 switches to write priority when 90 kilobytes (KB) of read commands are processed, and switches to read priority when 80 kilobytes (KB) of write commands are processed.

Under the above-described condition, the memory controller 300 repeatedly issued the read commands and the write commands at random and transferred each of read data and write data by 1024 kilobytes (KB). As a result of measuring transfer time, it took 2697824 nano seconds (ns) to complete transferring a total of 2048 kilobytes (KB) of data. Therefore, a measured throughput is approximately 759.130 megabytes per second (MB/s).

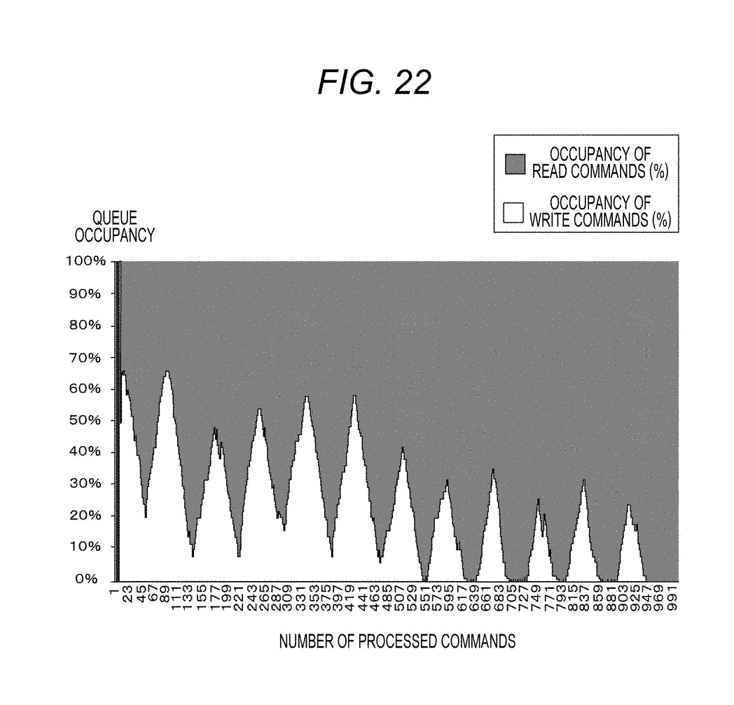

FIG. 22 is a graph representing an example of change in queue occupancy in a case where the threshold is changed in the second embodiment. The ordinate in this drawing represents a ratio of the write commands in an entire command queue 340. The abscissa in this drawing represents the number of processed commands.

Also, both the thresholds Nr and Nr were changed to 40. As a result, the memory controller 300 switches to write priority when 80 kilobytes (KB) of read commands are processed, and switches to read priority when 80 kilobytes (KB) of write commands are processed.

Under the above-described conditions, when the memory controller 300 similarly performed the random access, it took 2743416 nanoseconds (ns) to complete transferring 2048 kilobytes (KB) of data. Therefore, the measured throughput is approximately 746.515 megabytes per second (MB/s).

As illustrated in FIGS. 21 and 22, the occupancy of the write commands increases or decreases with the lapse of time. This is because the priority mode is alternately switched between the write priority mode and the read priority mode.

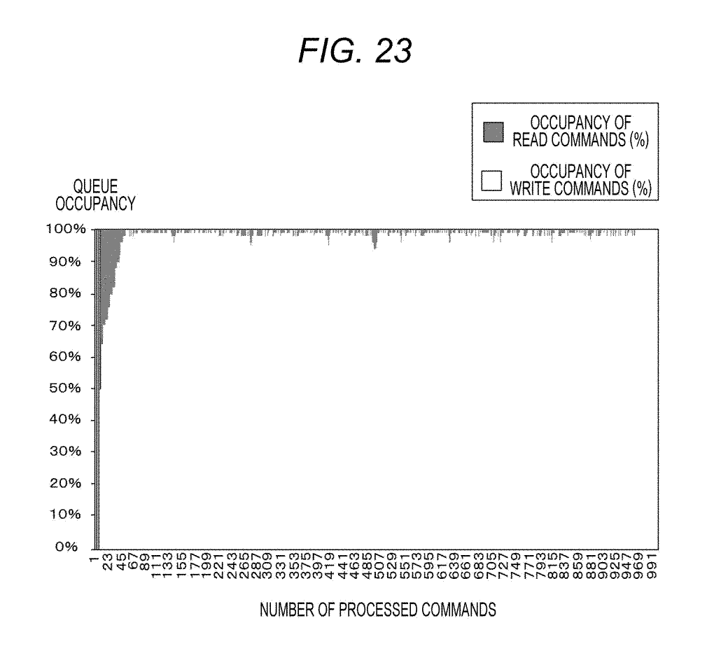

FIG. 23 is a graph representing an example of change in queue occupancy of the write commands in a comparative example fixed to read priority. Various conditions at the time of throughput measurement are set to be similar to those in FIG. 21.

As illustrated in FIG. 23, the occupancy of the write command increases with the lapse of time, and is maintained at around 100%. Therefore, the write commands stay in the command queue 340 for a long period, and a write speed decreases.

When the memory controller 300 performed the random access while fixing to read priority, it took 3091760 nano seconds (ns) to complete transferring 2048 kilobytes (KB) of data. Therefore, the measured throughput is approximately 662.406 megabytes per second (MB/s). In this manner, the throughput is lower than that in a case of switching between the read priority and the write priority.

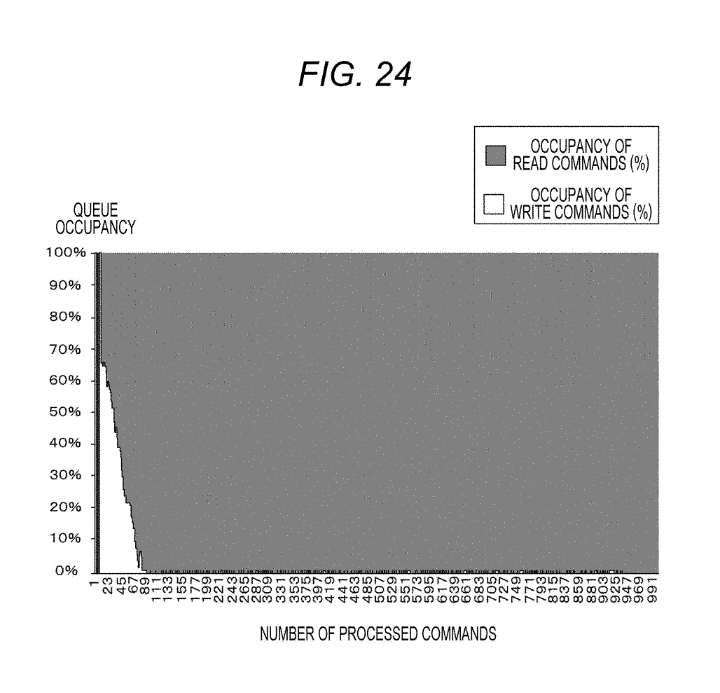

FIG. 24 is a graph representing an example of change in queue occupancy of the write commands in the comparative example fixed to write priority. Various conditions at the time of throughput measurement are set to be similar to those in FIG. 21.

As illustrated in FIG. 24, the occupancy of the write commands decreases with the lapse of time, and is maintained at around 0%. Therefore, the read commands stay in the command queue 340 over a period, and a read speed decreases.

When the memory controller 300 performs the random access while fixing to write priority, it took 379088 nanoseconds (ns) to complete transferring 2048000 bytes (B) data. Therefore, the measured throughput is approximately 539.219 megabytes per second (MB/s). In this manner, the throughput is lower than that in a case of switching between the read priority and the write priority.

By switching between the write priority mode and the read priority mode as illustrated in FIGS. 21 to 24, the throughput is improved as compared with the case where the mode is fixed.

As described above, according to the second embodiment of the present technology, since the priority mode is switched on the basis of the number of processed commands and all the priority commands are extracted from the queue, the memory controller 300 may sequentially issue the same type of requests. As a result, when issuing the write request after the read request, total time during which the write request stands by until the reading of the read data is completed is shortened, and the access speed may be improved.

### 3. Third Embodiment

In the second embodiment described above, the memory controller 300 switches the priority modes on the basis of the number of commands extracted from the command queue 340. However, if issue frequency of one of read commands and write commands by the host computer 100 is higher than the other one, it might take time to switch the priority mode. For example, if the issue frequency of the read commands is higher than that of the write commands, duration of the write priority mode becomes longer. As a result, the write speed increases while the read speed decreases. A memory controller 300 in a third embodiment is different from that of the first embodiment in that duration in a write priority mode and that in the read priority mode are made equal.

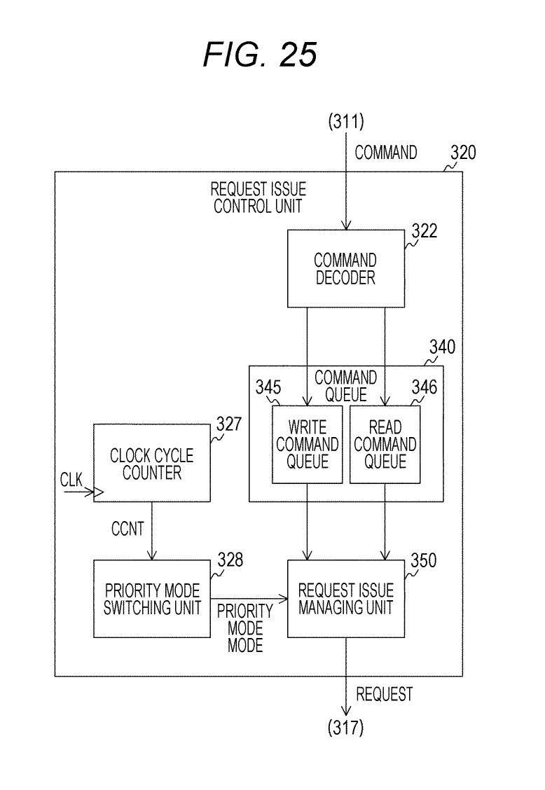

FIG. 25 is a view illustrating an example of operation of the memory controller 300 in the third embodiment. The memory controller 300 of the third embodiment is different from that of the second embodiment in including a clock cycle counter 327 in place of a processed command number counting unit 325. The memory controller 300 of the third embodiment is also different from that of the second embodiment in including a priority mode switching unit 328 in place of a priority mode switching unit 326.

The clock cycle counter 327 counts a counter value CCNT in synchronization with a clock signal CLK of a predetermined frequency. The clock cycle counter 327 supplies the counter value CCNT to the priority mode switching unit 328.

The priority mode switching unit 328 obtains time TIM elapsed after switching a priority mode on the basis of the counter value CCNT. For example, a value obtained by multiplying difference between a current counter value CCNT and the counter value CCNT when switching the priority mode by a clock cycle corresponds to the elapsed time TIM. Then, in a case where the elapsed time TIM is not shorter than a certain period of time Nt, the priority mode switching unit 328 switches the priority mode. By this control, the priority mode is switched at regular time intervals. If the certain period of time Nt is too long, one of a writing speed and a reading speed might significantly decrease with respect to the other. For this reason, it is desirable that the certain period of time Nt is a value with which a balance between the writing speed and the reading speed is not significantly deteriorated.

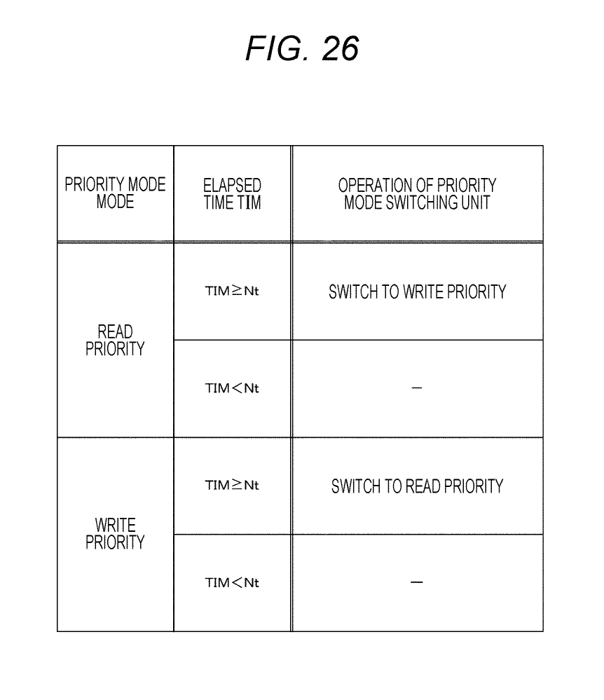

FIG. 26 is a view illustrating an example of operation of the priority mode switching unit 328 in the third embodiment. In a read priority mode, in a case where the elapsed time TIM is not shorter than the certain time Nt, the priority mode switching unit 328 switches to a write priority mode. On the other hand, in the write priority mode, in a case where the elapsed time TIM is not shorter than the certain period of time Nt, the priority mode switching unit 328 switches to the read priority mode.

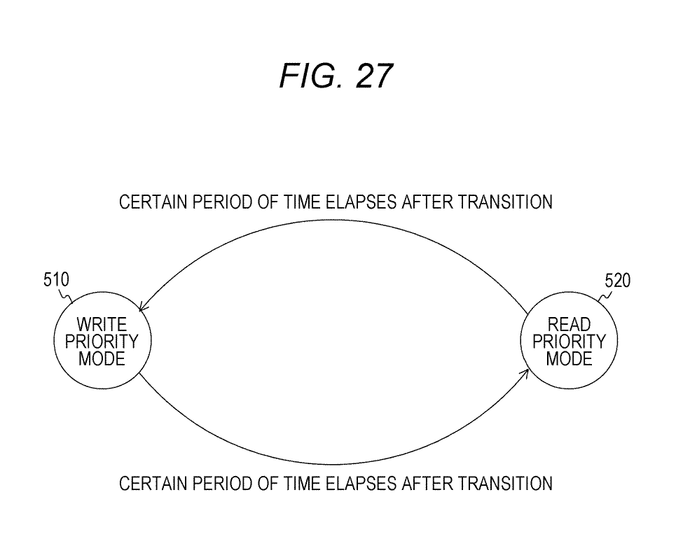

FIG. 27 is an example of a state transition diagram of the memory controller 300 in the third embodiment. When a certain period of time elapses after the transition to a read priority mode 520, the memory controller 300 makes the transition to a write priority mode 510. Also, when a certain period of time elapses after the transition to the write priority mode 510, the memory controller 300 makes the transition to the read priority mode 520.

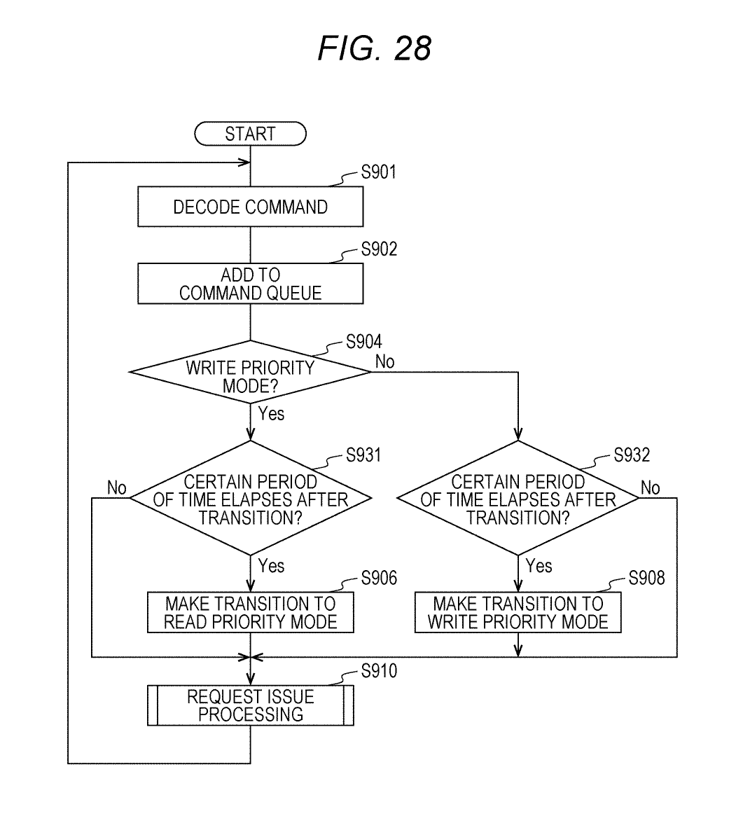

FIG. 28 is a view illustrating an example of operation of the memory controller 300 in the third embodiment. The operation of the memory controller 300 in the third embodiment is different from that of the first embodiment in that steps S931 to S932 are executed in place of steps S905 to S907, respectively.

In a case of the write priority mode (step S904: Yes), the memory controller 300 determines whether a certain time elapses after the transition to the write priority mode (step S931). In a case where the certain period of time elapses (step S931: Yes), the memory controller 300 makes the transition to the read priority mode (step S906).

In a case where a current priority mode is the read priority mode (step S904: No), the memory controller 300 determines whether a certain period of time elapses after the transition to the read priority mode (step S932). In a case where the certain period of time elapses (step S932: Yes), the memory controller 300 makes the transition to the write priority mode (step S908).

In a case where the certain period of time does not elapse after the transition (step S931 or step S932: No), or after step S906 or S908, the memory controller 300 executes request issue processing (step S910).

In this manner, according to the third embodiment of the present technology, since the priority mode is switched at regular intervals and all the priority commands are extracted from the queue, the memory controller 300 may continuously issue the same type of requests. As a result, it becomes possible to make duration in the read priority mode and that in the write priority mode equal, so that the write speed and the read speed may be made comparable approximately the same.

### 4. Fourth Embodiment

In the second embodiment described above, the memory controller 300 switches the priority modes on the basis of the number of commands extracted from the command queue 340. However, if issue frequency of the read command and that of the write command by the host computer 100 are unbalanced, it might take time to switch the priority mode. For example, if the issue frequency of the read commands is higher than that of the write commands, duration of the write priority mode becomes longer. As a result, the write speed increases while the read speed decreases. A memory controller 300 of a fourth embodiment is different from that of the second embodiment in that a writing speed and a reading speed are made approximately the same.

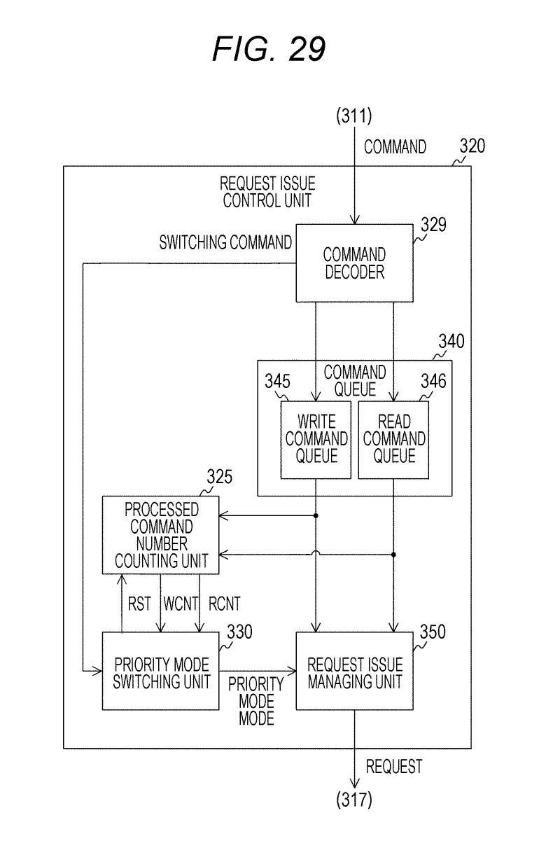

FIG. 29 is a block diagram illustrating a configuration example of a request issue control unit 320 in the fourth embodiment. The request issue control unit 320 of the fourth embodiment is different from that of the second embodiment in including a command decoder 329 and a priority mode switching unit 330 in place of a command decoder 322 and a priority mode switching unit 324, respectively.

The command decoder 329 is different from that of the second embodiment in that, in a case of decoding a switching command, the decoded switching command is supplied to the priority mode switching unit 330. Herein, the switching command is a command giving an instruction to switch to either a write priority mode or a read priority mode, and is issued as necessary by the host computer 100. For example, in a case where the writing speed is relatively low, the host computer 100 issues the switching command giving an instruction to switch to the write priority mode. On the other hand, in a case where the reading speed is relatively low, the host computer 100 issues the switching command giving an instruction to switch to the read priority mode.

The priority mode switching unit 330 switches the priority modes on the basis of each of the numbers of extracted commands WCNT and RCNT. Also, the priority mode switching unit 330 switches the priority mode according to the switching command.

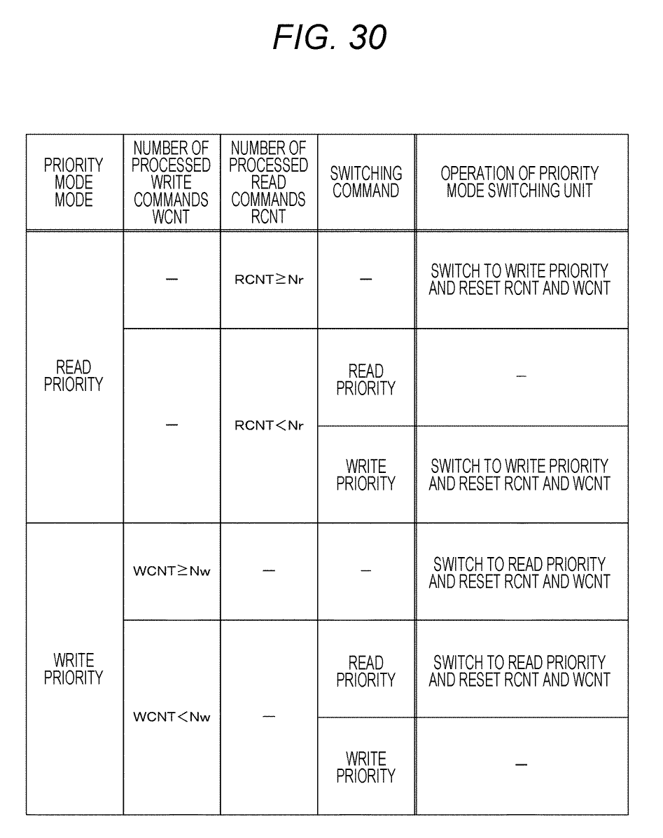

FIG. 30 is a view illustrating an example of operation of the priority mode switching unit 330 in the fourth embodiment. In the read priority mode, in a case where the number of read commands RCNT is not smaller than a threshold Nr, or in a case where the switching command indicates write priority, the priority mode switching unit 330 switches to write priority and resets a counter value. Also, in the write priority mode, in a case where the number of write commands WCNT is not smaller than the threshold Nr, or in a case where the switching command indicates read priority, the priority mode switching unit 330 switches to read priority and resets the counter value.

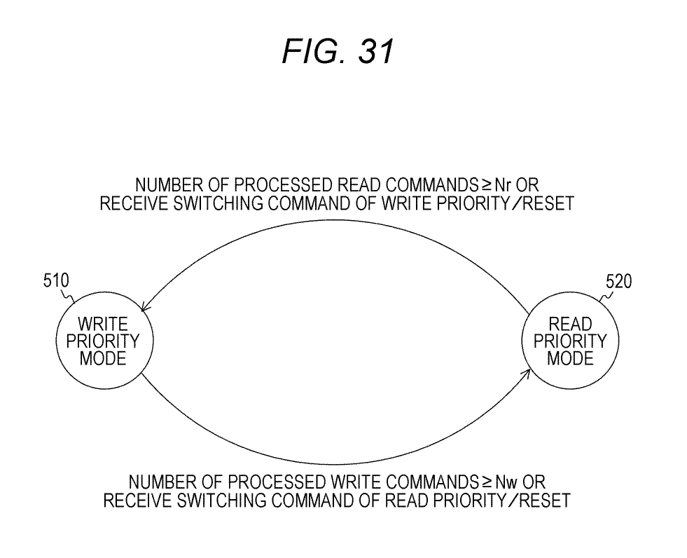

FIG. 31 is an example of a state transition diagram of the memory controller 300 in the fourth embodiment. In the read priority mode 520, in a case where the number of read commands RCNT is not smaller than the threshold Nr or the switching command indicates write priority, the memory controller 300 makes the transition to the write priority mode 510 and resets the counter value. Also, in the write priority mode 510, in a case where the number of write commands WCNT is not smaller than the threshold Nw or the switching command indicates read priority, the memory controller 300 makes the transition to the read priority mode 520 and resets the counter value.

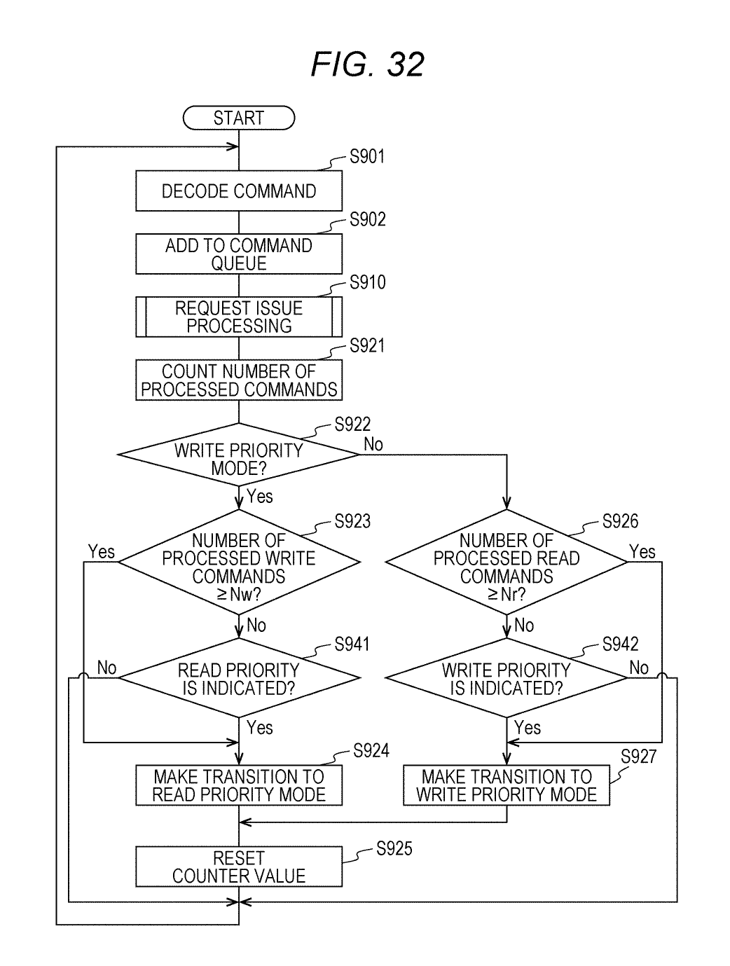

FIG. 32 is a view illustrating an example of operation of the memory controller 300 in the fourth embodiment. The operation of the memory controller 300 of the fourth embodiment is different from that of the second embodiment in that steps S941 and S942 are further executed.

In the write priority mode, in a case where the number of processed write commands is smaller than Nw (step S923: No), the memory controller 300 determines whether read priority is indicated by the switching command (step S941). In a case where the number of processed write command is not smaller than Nw (step S923: Yes) or read priority is indicated (step S941: Yes), the memory controller 300 makes the transition to the read priority mode (step S924).

Also, in the read priority mode, in a case where the number of processed read commands is smaller than Nr (step S926: No), the memory controller 300 determines whether write priority is indicated by the switching command (step S942). In a case where the number of processed read commands is not smaller than Nr (step S926: Yes) or write priority is indicated (step S942: Yes), the memory controller 300 makes the transition to the write priority mode (step S927).

In a case where read priority is not indicated (step S941: No), write priority is not indicated (step S942: No), or after step S925, the memory controller 300 repeats step S901.

Meanwhile, although the memory controller 300 determines whether the number of processed commands becomes larger than the threshold, as in the first embodiment, this may also determine whether the number of standby commands exceeds a threshold. In this case, the memory controller 300 switches the priority mode in a case where the number of standby commands exceeds the threshold or switching is indicated by the switching command.

Also, although the memory controller 300 determines whether the number of processed commands exceeds the threshold, as is the case with the third embodiment, it is also possible to determine whether a certain period of time elapses. In this case, the memory controller 300 switches the priority mode in a case where the certain period of time elapses after switching or the switching is indicated by the switching command.

As described above, according to the fourth embodiment of the present technology, since the memory controller 300 switches the priority mode according to the switching command, if the switching command is issued in a case where the writing speed and the reading speed are unbalanced, it is possible to make the speeds approximately the same.

### 5. Fifth Embodiment

In the first embodiment described above, the memory controller 300 counts the number of decoded commands in the command queue 340 and switches the mode according to the count value. However, in this mode control, in a case where a host command queue holding commands before decoding is additionally provided, a throughput might decrease. For example, it is assumed that the number of write commands is larger than that of read commands before decoding, and the number of write commands and that of host commands are approximately the same after decoding. At that time, in a write priority mode, there is a case where the memory controller 300 executes all the decoded write commands and makes the transition to a read priority mode even though the write command before decoding still remains in the host command queue. In such a case, switching of modes might be complicated, thereby decreasing the throughput. A memory controller 300 of a fifth embodiment is different from that of the first embodiment in that a throughput is improved in a configuration provided with a host command queue.

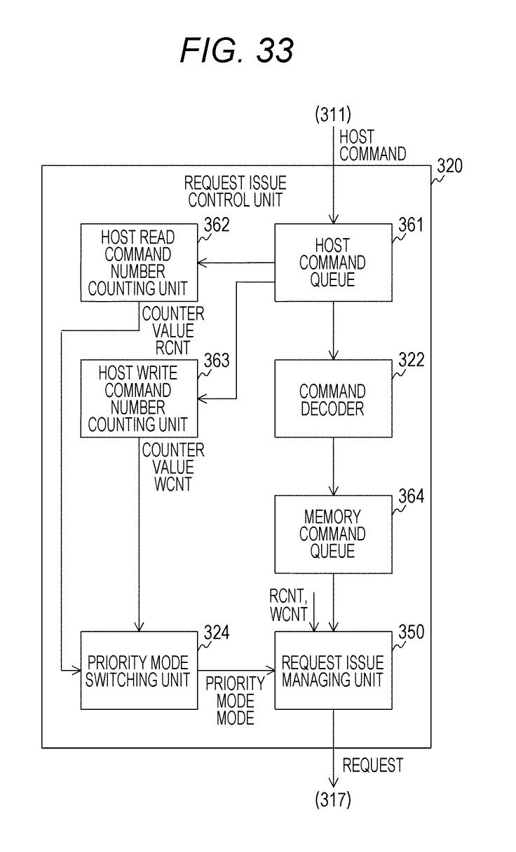

FIG. 33 is a block diagram illustrating a configuration example of a request issue control unit 320 in the fifth embodiment. The request issue control unit 320 of the fifth embodiment is provided with a host command queue 361 and a memory command queue 364 in place of a command queue 340. Also, the request issue control unit 320 of the fifth embodiment is provided with a host read command number counting unit 362 and a host write command number counting unit 363 in place of a standby read command number counting unit 321 and a standby write command number counting unit command queue 323, respectively.

The host command queue 361 holds commands from a host interface 311 as host commands. This host command specifies a logical address as described above. Among the host commands, a read command is hereinafter referred to as a “host read command”, and a write command is referred to as a “host write command”. The host command queue 361 holds the commands in order of arrival by a FIFO system. These host commands are extracted in order of arrival by a command decoder 322. Meanwhile, the host command queue 361 is an example of a host command holding unit recited in claims.

The command decoder 322 converts the logical address of the host command into a physical address. Herein, the physical address is an address allocated to each of storage elements in a non-volatile memory 410. Also, the command decoder 322 divides the host command according to difference between an access unit at the time of access by a host computer 100 and an access unit at the time of access by a memory controller 200. For example, in a case where the access unit on the host side is four kilobytes (kB) and the access unit on the memory controller side is two kilobytes (kB), the command decoder 322 divides each of the host commands into two. The command decoder 322 supplies the command subjected to decoding processing including address conversion and division to the memory command queue 364.

The memory command queue 364 holds the decoded command as a memory command. A configuration of the memory command queue 364 is similar to that of the command queue 340. Among the memory commands, a read command is hereinafter referred to as a “memory read command”, and a write command is referred to as a “memory write command”. Meanwhile, the memory command queue 364 is an example of a memory command holding unit recited in claims.

The host read command number counting unit 362 counts the number of host read commands held in the host command queue 361. The host read command number counting unit 362 supplies a counter value RCNT to a priority mode switching unit 324 and a request issue managing unit 350.

The host write command number counting unit 363 counts the number of host write commands held in the host command queue 361. The host write command number counting unit 363 supplies a counter value WCNT to the priority mode switching unit 324 and the request issue managing unit 350.

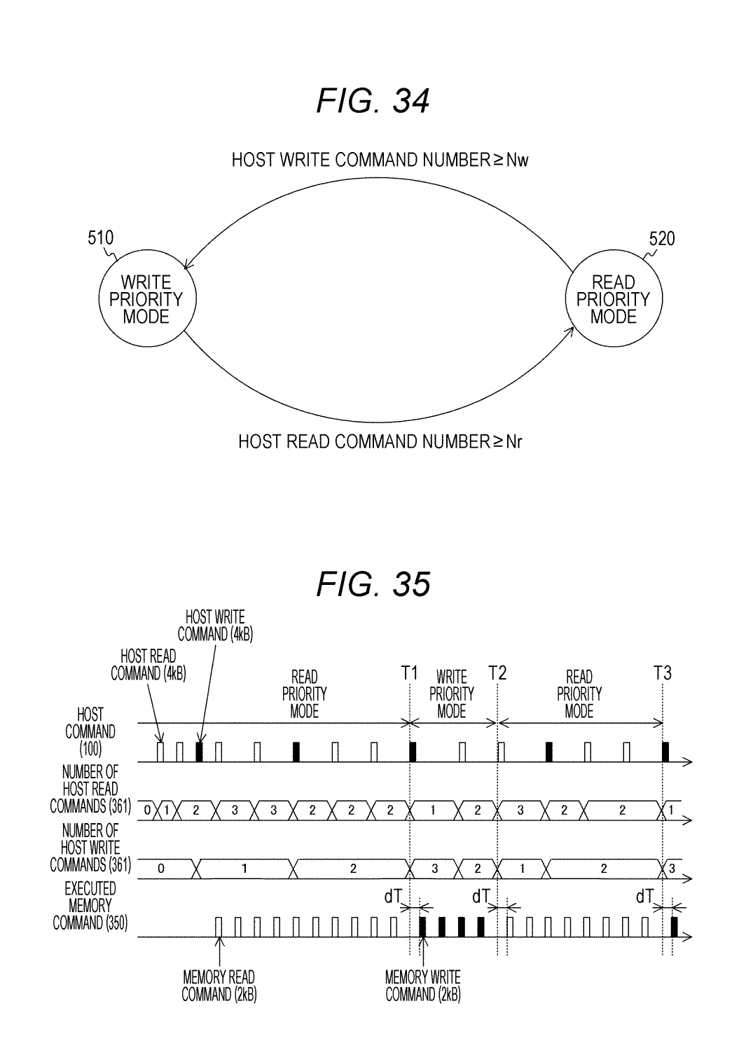

FIG. 34 is an example of a state transition diagram of the memory controller 300 according to the fifth embodiment. In a read priority mode 520, the memory controller 300 makes the transition to a write priority mode 510 when the number of standby host write commands (WCNT) becomes equal to or larger than a threshold Nw. On the other hand, in the write priority mode 510, when the number of standby host read commands (WCNT) becomes equal to or larger than a threshold Nr, the memory controller 300 makes the transition to the read priority mode 520.

FIG. 35 is a timing chart illustrating an example of operation of the memory controller 300 in the fifth embodiment. It is assumed that the number of entries of the host command queue 361 is, for example, “four”. Also, for example, it is assumed that the host write command is issued once each time the host read command is issued twice in succession. Then, it is assumed that the mode in an initial state is the read priority mode, and Nr and Nw are both set to “three”.

At timing T1 at which the host write command is issued for the third time, the number of host write commands WCNT in the host command queue 361 becomes “three”, which is not smaller than Nw. Therefore, the memory controller 300 shifts to the write priority mode. Then, at timing overhead dT after the timing T1, the memory controller 300 starts continuous execution of the memory write commands.

Then, at timing T2 at which the host read command is issued twice from the timing T1, the number of host read commands RCNT in the host command queue 361 becomes “three”, which is not smaller than Nr. Therefore, the memory controller 300 shifts to the read priority mode. Then, the memory controller 300 starts continuously executing the memory read commands at timing the overhead dT after the timing T2.

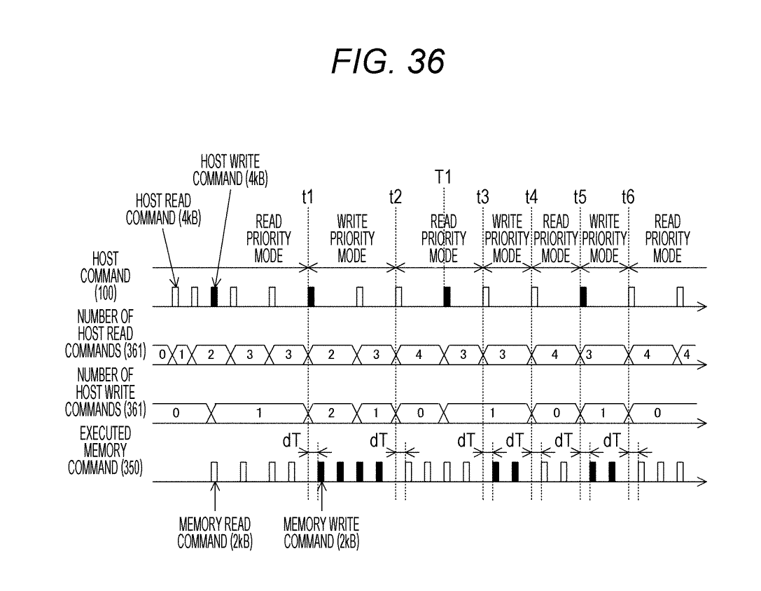

FIG. 36 is a timing chart illustrating an example of the operation of the memory controller in a comparative example. The memory controller of this comparative example provided with the host command queue 361 and the memory command queue 364 switches the mode on the basis of a count value of the memory commands as in the first embodiment. Also, an issue ratio between the host write commands and the host read commands is assumed to be similar to that in FIG. 35. The number of entries of the memory command queue 364 is “eight”, and Nr and Nw are both “four”.

At timing t1 at which the host write command is issued for the second time, the number of memory write commands WCNT in the memory command queue 364 becomes “four”, which is not smaller than Nw. Therefore, the memory controller of the comparative example shifts to the write priority mode. Then, the memory controller starts continuously executing the memory write commands at timing the overhead dT after the timing t1.

Then, at timing t2 at which the host read command is issued twice from the timing t1, the number of memory read commands RCNT in the memory command queue 364 becomes “four”, which is not smaller than Nr. Therefore, the memory controller of the comparative example shifts to the read priority mode. Then, the memory controller 300 starts continuously executing the memory read commands at timing the overhead dT after the timing t2.

As illustrated in FIG. 34, the memory controller of the comparative example switches the priority mode three times before the timing T1 at which the host write command is issued for the third time. This number of times of switching is larger than that in the fifth embodiment in which the priority mode is switched only twice before the timing T1, as illustrated in FIG. 35. This is because the write command in the memory command queue 364 is exhausted even though the write command remains in the host command queue 361, and the read command is forced to be executed, so that it is switched to the read priority mode.

In contrast to this comparative example, since the memory controller 300 switches the priority mode on the basis of the number of commands in the host command queue 361, it is possible to decrease the frequency of switching to improve the throughput.

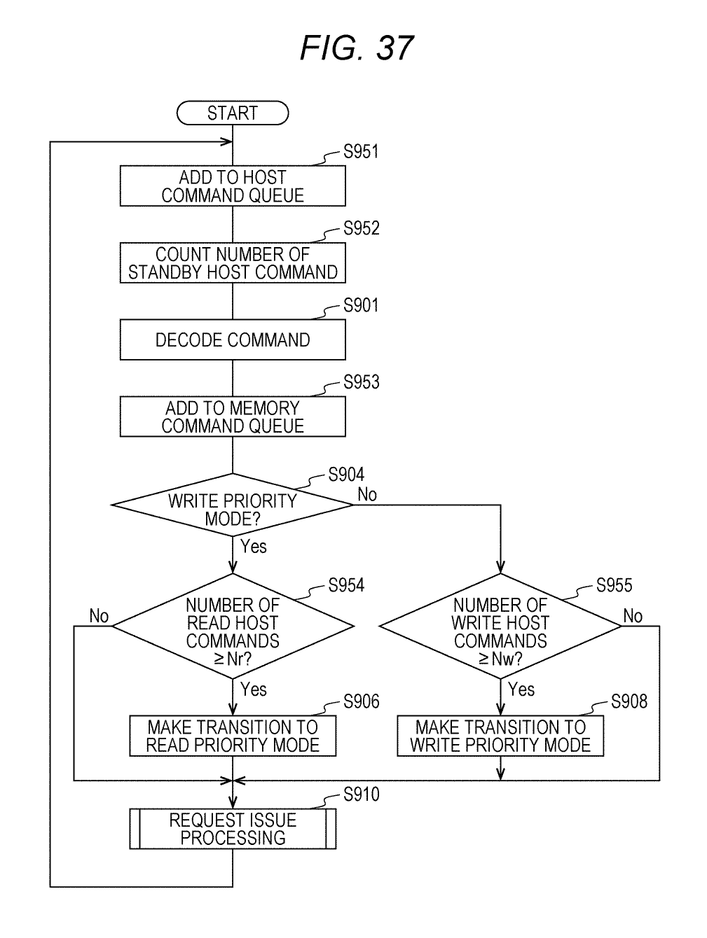

FIG. 37 is a flowchart illustrating an example of the operation of the memory controller 300 in the fifth embodiment. The memory controller 300 adds the host command to the host command queue 361 (step S951), and counts the number of standby host commands (step S952). Also, the memory controller 300 extracts the host commands in order of arrival to decode (step S901) and adds them to the memory command queue 364 (step S953).

Then, the memory controller 300 determines whether the current priority mode is the write priority mode (step S904). In a case of the write priority mode (step S904: Yes), the memory controller 300 determines whether the number of standby host read commands is not smaller than Nr (step S954). In a case where the number of read commands is not smaller than Nr (step S954: Yes), the memory controller 300 makes the transition to the read priority mode (step S906).

On the other hand, in a case where the current priority mode is the read priority mode (step S904: No), the memory controller 300 determines whether the number of standby host write commands is not smaller than Nw (step S955). In a case where the number of write commands is not smaller than Nw (step S955: Yes), the memory controller 300 makes the transition to the write priority mode (step S908).

In a case where the number of read commands is smaller than Nr (step S954: No) or after step S906, the memory controller 300 executes request issue processing (step S910). Also, in a case where the number of write commands is smaller than Nw (step S955: No) or after step S908, the memory controller 300 executes the request issue processing (step S910). After step S910, the memory controller 300 repeats step S951 and subsequent steps.

As described above, according to the fifth embodiment of the present technology, since the priority mode is switched on the basis of the number of standby host commands, the frequency of switching modes may be reduced in a configuration in which the host command queue 361 is provided. As a result, the throughput may be improved.

### 6. Sixth Embodiment

In the second embodiment described above, the memory controller 300 switches the priority mode depending on whether the number of commands extracted to be executed exceeds a fixed threshold. However, if the threshold is inappropriate, the switching cannot be performed efficiently, and a throughput is not be sufficiently improved. A memory controller 300 according to a sixth embodiment is different from that of the second embodiment in that an appropriate threshold is set.

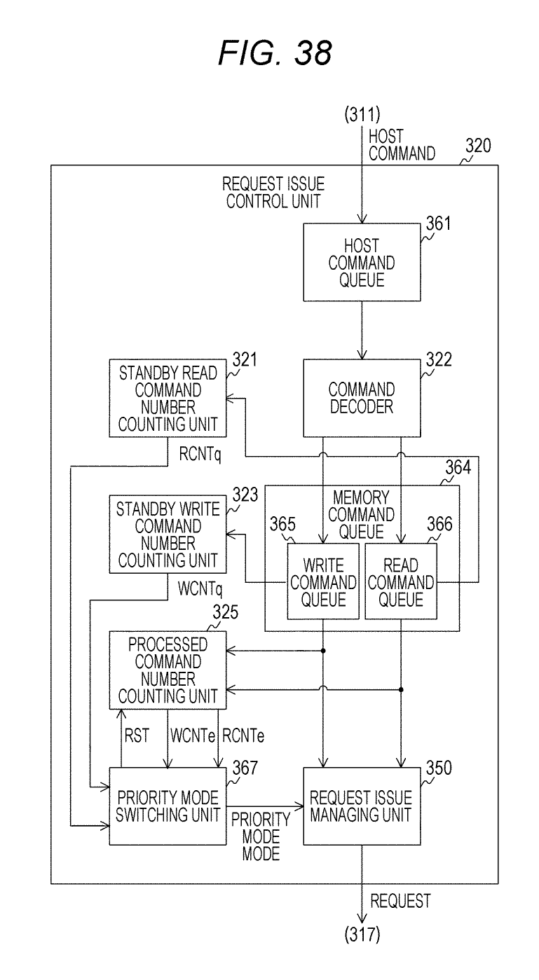

FIG. 38 is a block diagram illustrating a configuration example of a request issue control unit 320 in the sixth embodiment. The request issue control unit 320 of the sixth embodiment is different from that of the second embodiment in including a host command queue 361, a memory command queue 364, and a priority mode switching unit 367 in place of a command queue 340 and a priority mode switching unit 326. Also, the request issue control unit 320 of the sixth embodiment is different from that of the second embodiment in further including a standby read command number counting unit 321 and a standby write command number counting unit 323.

A configuration of the host command queue 361 of the sixth embodiment is similar to that of the fifth embodiment. The memory command queue 364 is also provided with a write command queue 365 and a read command queue 366. Configurations of these queues are similar to that of the second embodiment.

The standby read command number counting unit 321 of the sixth embodiment counts the number of memory read commands held in the read command queue 366 as the number of standby read commands RCNTq. Also, the standby read command number counting unit 322 of the sixth embodiment counts the number of memory write commands held in the write command queue 365 as the number of standby write commands WCNTq. Also, a processed command number counting unit 325 of the sixth embodiment counts the number of processed memory write commands and the number of processed memory read commands as WCNTq and RCNTq, respectively.

The priority mode switching unit 367 sets Nw and Nr to initial values in an initial state. Also, the priority mode switching unit 367 switches to a read priority mode when the number of processed write commands WCNTq is not smaller than Nw in a write priority mode. Then, the priority mode switching unit 367 resets the counter values WCNTe and RCNTe to initial values, and sets Nw to the number of standby write commands WCNTq.

On the other hand, the priority mode switching unit 367 switches to the write priority mode when the number of processed read commands RCNTq is not smaller than Nr in the read priority mode. Then, the priority mode switching unit 367 resets the counter values WCNTe and RCNTe to initial values, and sets Nr to the number of standby read commands WCNTq. In this manner, the threshold Nw is set to the number of standby write commands WCNTq when switching to the write priority mode, and the threshold Nr is set to the number of standby read commands RCNTq when switching to the read priority mode. That is, the threshold is dynamically changed.

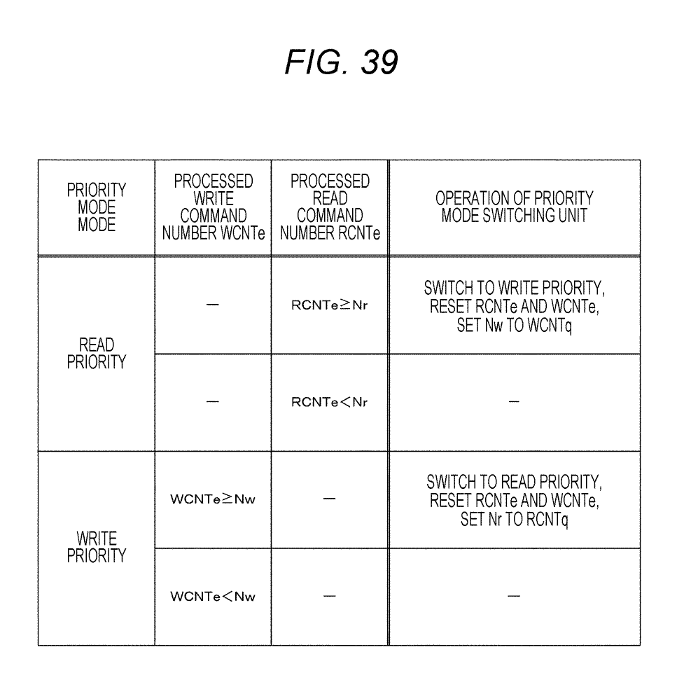

FIG. 39 is a view illustrating an example of operation of the priority mode switching unit 367 in the sixth embodiment. In the read priority mode, when the number of processed read commands (RCNTe) becomes equal to or larger than the threshold Nr, the priority mode switching unit 367 switches to the write priority mode and resets the counter value. This Nr is the number of standby read commands RCNTq when switching to the read priority mode.

On the other hand, in the write priority mode, the priority mode switching unit 367 switches to the read priority mode and resets the counter value when the number of processed write commands (WCNTe) becomes equal to or larger than the threshold Nw. This Nw is the number of standby write commands WCNTq when switching to the write priority mode.

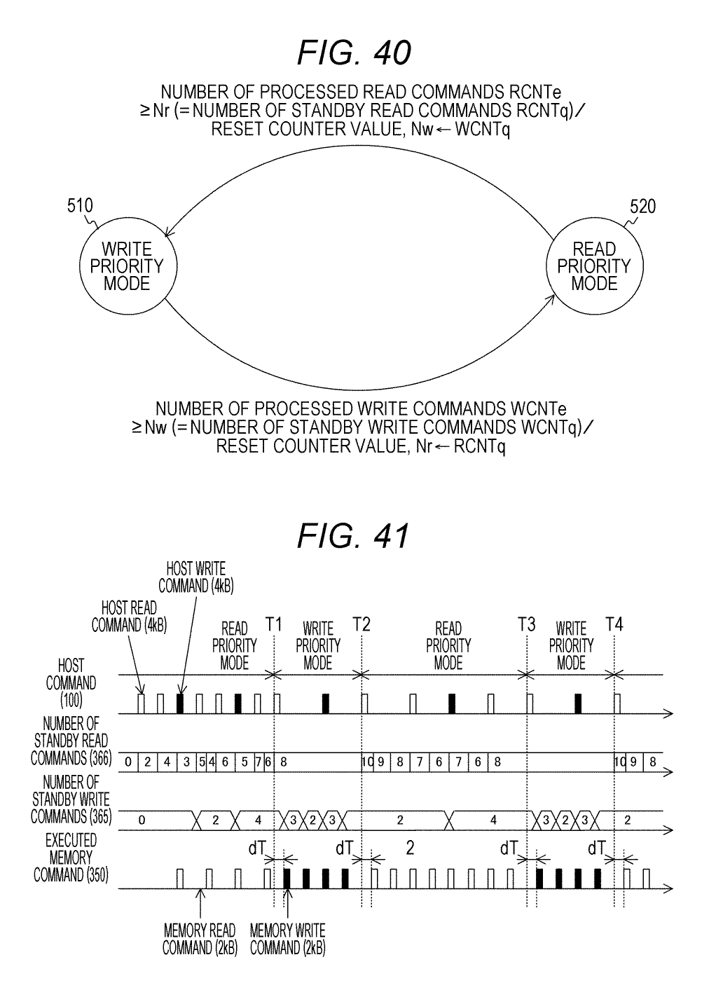

FIG. 40 is an example of a state transition diagram of the memory controller 300 in the second embodiment. In the read priority mode 520, when the number of processed read commands (RCNTe) becomes equal to or larger than the threshold Nr (=RCNTq), the memory controller 300 makes the transition to a write priority mode 510 and resets the counter values WCNTe and RCNTe. Also, the memory controller 300 sets the threshold Nw to the number of standby write commands WCNTq.

On the other hand, in the write priority mode 510, when the number of processed write commands (WCNTe) becomes equal to or larger than the threshold Nw, the memory controller 300 makes the transition to the read priority mode 520 and resets the counter values WCNTe and RCNTe. Also, the memory controller 300 sets the threshold Nr to the number of standby read commands RCNTq.

FIG. 41 is a timing chart illustrating an example of operation of the memory controller 300 in the sixth embodiment. It is assumed that the number of entries of the write command queue 365 and the read command queue 366 is, for example, “eight”. Also, for example, it is assumed that the host write command is issued once each time the host read command is issued twice in succession. Then, it is assumed that the mode in the initial state is the read priority mode, and the initial values of Nr and Nw are both “four”.

At timing T1, the number of processed read commands becomes “four”, which is not smaller than Nr. Therefore, the memory controller 300 switches to the write priority mode, and sets Nw to the number of standby write commands “four” at the time of switching. Then, at the timing T2 at which four memory write commands are executed after the timing T1, the number of processed write commands becomes “four”, which is not smaller than Nw. Therefore, the memory controller 300 switches to the read priority mode, and sets Nr to the number of standby read commands “eight” at the time of switching.

Then, at timing T3 at which the eight memory read commands are executed after the timing T2, the number of processed read commands becomes “eight”, which is not smaller than Nr. Therefore, the memory controller 300 switches to the write priority mode, and sets Nw to the number of standby read commands “four” at the time of switching. In this manner, the thresholds Nw and Nr are dynamically changed according to the number of commands held in the memory command queue 364. As a result, it is possible to switch modes efficiently. For example, at timing T2, more read commands than the initial value “four” of the threshold Nr are held in the read command queue 366. In this case, if the threshold Nr remains at the initial value, there is a risk of switching to the write priority mode in a state in which not all the memory read commands in the queue are extracted. However, since the memory controller 300 newly sets Nr to “eight” which is the number of standby read commands, the mode may be switched efficiently by setting an appropriate threshold.

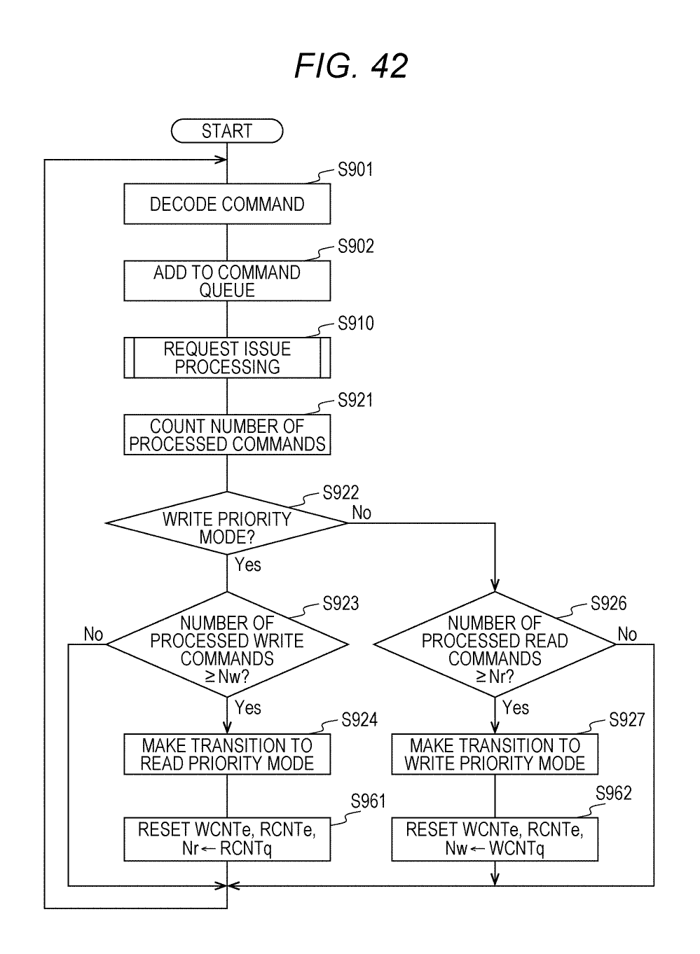

FIG. 42 is a flowchart illustrating an example of the operation of the memory controller 300 in the sixth embodiment. The memory controller 300 is different from that of the second embodiment illustrated in FIG. 20 in executing steps S961 and S962 in place of step S925.

Upon transition to the read priority mode (step S924), the memory controller 300 resets the counter values WCNTe and RCNTe, and sets the threshold Nr to the number of standby read commands RCNTq (step S961). Also, upon transition to the write priority mode (step S927), the memory controller 300 resets the counter values WCNTe and RCNTe, and sets the threshold Nw to the number of standby read commands WCNTq (step S962).

As described above, according to the sixth embodiment of the present technology, since the threshold is set to the number of standby commands at the time of priority mode switching, it is possible to efficiently switch the priority mode with an appropriate threshold. As a result, the throughput may be improved.

Meanwhile, in each of the above-described embodiments, the memory controller 300 extracts the command which is not the priority command after extracting all of the priority commands; however, it is also possible to extract the command which is not the priority command before extracting all the priority commands. For example, assume a configuration in which two non-volatile memories A and B are connected to the memory controller 300. In this configuration, there is a case where the memory controller 300 cannot extract all the write commands from the non-volatile memory A because the non-volatile memory A is in processing (busy) in the write priority mode and the like. Even in such a case, the memory controller 300 may extract the read command if there is a non-priority read command in the non-volatile memory B in an idle state. That is, the memory controller 300 may preferentially extract the priority commands in sequence from the non-volatile memory, and then extract the command which is not the priority command.

Meanwhile, the above-described embodiments describe an example of embodying the present technology, and there is a correspondence relationship between matters in the embodiments and the matters specifying the invention in claims. Similarly, there is a correspondence relationship between the matters specifying the invention in claims and the matters in the embodiments of the present technology having the same names. However, the present technology is not limited to the embodiments and may be embodied with various modifications of the embodiment without departing from the spirit thereof.

Also, the procedures described in the above-described embodiments may be considered as a method including a series of procedures and may be considered as a program for allowing a computer to execute the series of procedures and a recording medium which stores the program. A compact disc (CD), a MiniDisc (MD), a digital versatile disc (DVD), a memory card, a Blu-Ray™ disc and the like may be used, for example, as the recording medium.

Meanwhile, the effects are not necessarily limited to the effects herein described and may be any of the effects described in the present disclosure.

Meanwhile, the present technology may also have a following configuration.

(1) A memory controller provided with:

a holding unit which, each time any one of two different types of commands is input, holds the input command;

a switching unit which switches a priority command which should have priority out of the two commands from one of the two commands to the other; and

a command processing unit which preferentially extracts priority commands sequentially from the holding unit, and then sequentially extracts commands which are not the priority commands from the holding unit.

(2) The memory controller according to (1) described above,

in which the command processing unit sequentially extracts all the priority commands from the holding unit, and then sequentially extracts the commands which are not the priority commands from the holding unit.

(3) The memory controller according to (1) described above, further provided with:

a counting unit which counts the number of each of the two commands to generate a count value,

in which the switching unit switches the priority command on the basis of whether the count value of each of the two commands exceeds a predetermined threshold.

(4) The memory controller according to (3) described above,

in which the counting unit counts the number of the commands held in the holding unit.

(5) The memory controller according to (3) described above,

in which the counting unit counts the number of the commands extracted from the holding unit.

(6) The memory controller according to (3) described above, further provided with:

an address converting unit which performs logical to physical address conversion to convert a logical address specified by the command to a physical address,

in which the holding unit includes

a memory command holding unit which holds the command subjected to the logical to physical address conversion as a memory command, and

a host command holding unit which holds the command before the address conversion is performed as a host command.

(7) The memory controller according to (6) described above,

in which the counting unit counts the number of host commands held in the host command holding unit.

(8) The memory controller according to (6) described above,

in which the counting unit counts the number of memory commands held in the memory command holding unit as the number of standby commands, and counts the number of memory commands extracted from the memory command holding unit as the number of processed commands,

the threshold is the number of standby commands when the priority command is switched, and

the switching unit switches the priority command on the basis of whether the number of processed commands exceeds the threshold.

(9) The memory controller according to any one of (1) to (8) described above,

in which the priority mode switching unit switches the priority command each time a certain period of time elapses.

(10) The memory controller according to any one of (1) to (8) described above,

in which the switching unit switches the priority command according to a specific command giving an instruction to switch the priority command.

(11) The memory controller according to any one of (1) to (10) described above,

in which one of the two commands is a read command giving an instruction to read data,

the other of the two commands is a write command giving an instruction to write data, and

the holding unit includes

a read command holding unit which holds the read command, and

a write command holding unit which holds the write command.

(12) A memory system provided with:

a memory cell;

a holding unit which, each time any one of two different commands for accessing the memory cell is input, holds the input command;

a switching unit which switches a priority command which should have priority out of the two commands from one of the two commands to the other; and

a command processing unit which preferentially extracts priority commands sequentially from the holding unit, and then sequentially extracts commands which are not the priority commands from the holding unit.

(13) A method of controlling a memory controller including:

a holding step of, each time any one of two different types of commands is input, holding the input command in a holding unit;

a switching step of switching a priority command which should have priority out of the two commands from one of the two commands to the other; and

a command processing step of preferentially extracting priority commands sequentially from the holding unit, and then sequentially extracting commands which are not the priority commands from the holding unit.

### REFERENCE SIGNS LIST

100 Host computer
200 Storage
300 Memory controller
311 Host interface
312 RAM
313 CPU
314 ECC processing unit
315 ROM
316, 415 Bus
317 Memory interface
320 Request issue control unit
321 Standby read command number counting unit
322, 329 Command decoder
323 Standby write command number counting unit
324, 326, 328, 330, 367 Priority mode switching unit
325 Processed command number counting unit
327 Clock cycle counter
340 Command queue
341 Command holding unit
345, 365 Write command queue
346, 366 Read command queue
350 Request issue managing unit
351 Extracted command switch control unit
352 Extracting unit
353 Request issuing unit
361 Host command queue
362 Host read command number counting unit
363 Host write command number counting unit
364 Memory command queue
400 Memory bank
410 Non-volatile memory
411 Data buffer
412 Memory cell array
413 Driver
414 Address decoder
416 Control interface
417 Memory control unit

1. A memory controller comprising:
a holding unit which, each time any one of two different types of commands is input, holds the input command;
a switching unit which switches a priority command which should have priority out of the two commands from one of the two commands to the other; and
a command processing unit which preferentially extracts priority commands sequentially from the holding unit, and then sequentially extracts commands which are not the priority commands from the holding unit.

2. The memory controller according to claim 1,
wherein the command processing unit sequentially extracts all the priority commands from the holding unit, and then sequentially extracts the commands which are not the priority commands from the holding unit.

3. The memory controller according to claim 1, further comprising:
a counting unit which counts the number of each of the two commands to generate a count value,
wherein the switching unit switches the priority command on the basis of whether the count value of each of the two commands exceeds a predetermined threshold.

4. The memory controller according to claim 3,
wherein the counting unit counts the number of the commands held in the holding unit.

5. The memory controller according to claim 3,
wherein the counting unit counts the number of the commands extracted from the holding unit.

6. The memory controller according to claim 3, further comprising:
an address converting unit which performs logical to physical address conversion to convert a logical address specified by the command to a physical address,
wherein the holding unit includes
a memory command holding unit which holds the command subjected to the logical to physical address conversion as a memory command, and
a host command holding unit which holds the command before the address conversion is performed as a host command.

7. The memory controller according to claim 6,
wherein the counting unit counts the number of host commands held in the host command holding unit.

8. The memory controller according to claim 6,
wherein the counting unit counts the number of memory commands held in the memory command holding unit as the number of standby commands, and counts the number of memory commands extracted from the memory command holding unit as the number of processed commands,
the threshold is the number of standby commands when the priority command is switched, and
the switching unit switches the priority command on the basis of whether the number of processed commands exceeds the threshold.

9. The memory controller according to claim 1,
wherein the priority mode switching unit switches the priority command each time a certain period of time elapses.

10. The memory controller according to claim 1,
wherein the switching unit switches the priority command according to a specific command giving an instruction to switch the priority command.

11. The memory controller according to claim 1,
wherein one of the two commands is a read command giving an instruction to read data,
the other of the two commands is a write command giving an instruction to write data, and
the holding unit includes
a read command holding unit which holds the read command, and
a write command holding unit which holds the write command.

12. A memory system comprising:
a memory cell;
a holding unit which, each time any one of two different commands for accessing the memory cell is input, holds the input command;
a switching unit which switches a priority command which should have priority out of the two commands from one of the two commands to the other; and
a command processing unit which preferentially extracts priority commands sequentially from the holding unit, and then sequentially extracts commands which are not the priority commands from the holding unit.

13. A method of controlling a memory controller comprising:
a holding step of, each time any one of two different types of commands is input, holding the input command in a holding unit;
a switching step of switching a priority command which should have priority out of the two commands from one of the two commands to the other; and
a command processing step of preferentially extracting priority commands sequentially from the holding unit, and then sequentially extracting commands which are not the priority commands from the holding unit.
